(19) United States
(12) Patent Application Publication
(10) Pub. No.: US 2025/0015661 A1
(43) Pub. Date: Jan. 9, 2025

(54) ROTARY ELECTRIC MACHINE

(71) Applicant: DENSO CORPORATION, Kariya-city (JP)

(72) Inventor: YUKI MAWATARI, Kariya-city (JP)

(21) Appl. No.: 18/891,914

(22) Filed: Sep. 20, 2024

Related U.S. Application Data
(63) Continuation of application No. PCT/JP2023/006748, filed on Feb. 24, 2023.

(30) Foreign Application Priority Data
Mar. 24, 2022 (JP) 2022-048612

(51) Int. Cl. H02K 3/47; H02K 15/06

(52) U.S. Cl. CPC H02K 3/47; H02K 15/061

(57) ABSTRACT

A rotary electric machine includes a field element having magnetic poles, and an armature having a toothless structure. The armature includes a multiphase armature winding. The field element and the armature faces each other in a radial direction. A winding holding member has a cylindrical shape, and the armature winding is attached to the winding holding member such that conductor portions of the armature winding are arranged in a circumferential direction. A cylindrical covering member has a cylindrical shape and covers the conductor portions of the armature winding. The conductor portions of the armature winding are interposed between the winding holding member and the cylindrical covering member. A resin is interposed between the winding holding member and the cylindrical covering member. The cylindrical covering member covers a facing portion of the armature winding that faces the field element in the radial direction.

### CROSS REFERENCE TO RELATED APPLICATIONS

The present application is a continuation application of International Patent Application No. PCT/JP2023/006748 filed on Feb. 24, 2023, which designated the U.S. and claims the benefit of priority from Japanese Patent Application No. 2022-048612 filed on Mar. 24, 2022. The disclosures of all the above applications are incorporated herein.

### TECHNICAL FIELD

The present disclosure relates to a rotary electric machine.

### BACKGROUND

Conventionally, a rotary electric machine includes a field element including a magnet portion having magnetic poles whose polarities alternate in a circumferential direction, and an armature including a multiphase armature winding.

### SUMMARY

According to at least one embodiment of the present disclosure, a rotary electric machine includes a field element, an armature, a winding holding member, a cylindrical covering member, and a resin. The field element has magnetic poles, and the armature has a toothless structure. The armature includes a multiphase armature winding. The field element and the armature face each other in a radial direction of the rotary electric machine. The winding holding member has a cylindrical shape. The armature winding is attached to the winding holding member such that conductor portions of the armature winding are arranged in a circumferential direction of the rotary electric machine. The cylindrical covering member has a cylindrical shape and covers the conductor portions of the armature winding. The conductor portions of the armature winding are interposed between the winding holding member and the cylindrical covering member. The resin is interposed between the winding holding member and the cylindrical covering member. The cylindrical covering member covers a facing portion of the armature winding that faces the field element in the radial direction.

At least one embodiment of the present disclosure is a method of manufacturing a rotary electric machine. The rotary electric machine includes a field element having magnetic poles, and an armature having a toothless structure. The armature includes a multiphase armature winding. The field element and the armature are arranged to face each other in a radial direction of the rotary electric machine. The method includes attaching the armature winding to a winding holding member having a cylindrical shape to cause conductor portions of the armature winding to be arranged in a circumferential direction of the rotary electric machine. The method includes attaching a cylindrical covering member to a side of each of the conductor portions facing away from the winding holding member such that the cylindrical covering member covers a facing portion of the armature winding that faces the field element in the radial direction. The method includes filling a gap between the winding holding member and the cylindrical covering member with resin.

### BRIEF DESCRIPTION OF THE DRAWINGS

The details of one or more embodiments are set forth in the accompanying drawings and the description below. Other features and advantages will be apparent from the description and drawings, and from the claims. In the drawings:

FIG. 1 is a longitudinal cross-sectional view of a rotary electric machine according to a first embodiment;

FIG. 2A is a perspective view illustrating an appearance of a stator unit;

FIG. 2B is a perspective view illustrating an appearance of the stator unit;

FIG. 3 is a top view of the stator unit;

FIG. 4A is a cross-sectional view taken along line 4a-4a in FIG. 3;

FIG. 4B is a cross-sectional view taken along line 4b-4b in FIG. 3;

FIG. 5 is an exploded perspective view of a core assembly;

FIG. 6A is a longitudinal cross-sectional view of the core assembly;

FIG. 6B is a transverse cross-sectional view of the core assembly;

FIG. 7 is a perspective view of a position restriction member;

FIG. 8 is a perspective view illustrating a state in which the position restriction member is assembled to the core assembly;

FIG. 9A is a perspective view illustrating a winding segment;

FIG. 9B is a perspective view illustrating a winding segment;

FIG. 10A is a perspective view illustrating a position restriction member;

FIG. 10B is an exploded perspective view illustrating the position restriction member;

FIG. 11A is a longitudinal cross-sectional view of the stator unit;

FIG. 11B is a longitudinal cross-sectional view of the stator unit;

FIG. 12 is a perspective view of a wiring module;

FIG. 13 is an exploded perspective view of the stator unit;

FIG. 14 is a perspective view for explaining an assembling process of the stator unit;

FIG. 15 is a perspective view for explaining an assembling process of the stator unit;

FIG. 16 is a perspective view for explaining an assembling process of the stator unit;

FIG. 17 is a perspective view for explaining an assembling process of the stator unit;

FIG. 18A is a longitudinal cross-sectional view of the stator unit;

FIG. 18B is a longitudinal cross-sectional view of the stator unit;

FIG. 19 is an enlarged transverse cross-sectional view illustrating a stator core, intermediate conductor portions, and a coil cover;

FIG. 20 is a view illustrating a mold apparatus for preparing a molded resin portion;

FIG. 21 is a cross-sectional view illustrating a cross section of a conductor-gathered portion in the winding segment;

FIG. 22A is a view for explaining resin filling performed by a resin forming apparatus;

FIG. 22B is a view for explaining resin filling performed by a resin forming apparatus;

FIG. 23 is a view for explaining the resin filling performed by the resin forming apparatus;

FIG. 24 is a longitudinal cross-sectional view of another configuration of the stator unit;

FIG. 25 is a view illustrating a mask apparatus in a mold apparatus;

FIG. 26A is a perspective view illustrating an appearance of a stator unit according to a second embodiment;

FIG. 26B is a perspective view illustrating an appearance of the stator unit according to the second embodiment;

FIG. 27 is a top view of the stator unit;

FIG. 28A is a cross-sectional view taken along line 28a-28a in FIG. 27;

FIG. 28B is a cross-sectional view taken along line 28b-28b in FIG. 27;

FIG. 29 is a perspective view illustrating a core assembly and a position restriction member in an exploded state;

FIG. 30A is a longitudinal cross-sectional view of the stator unit;

FIG. 30B is a longitudinal cross-sectional view of the stator unit;

FIG. 31A is a perspective view illustrating an appearance of a stator unit according to a third embodiment;

FIG. 31B is a perspective view illustrating an appearance of the stator unit according to the third embodiment;

FIG. 32A is a longitudinal cross-sectional view of the stator unit;

FIG. 32B is a longitudinal cross-sectional view of the stator unit;

FIG. 33 is an exploded perspective view of the stator unit;

FIG. 34 is an exploded perspective view of the stator unit;

FIG. 35 is a perspective view illustrating an appearance of a stator unit according to a fourth embodiment;

FIG. 36 is a perspective view illustrating a state in which a position restriction member is separated in the stator unit;

FIG. 37 is a perspective view illustrating an appearance of a stator unit according to a fifth embodiment;

FIG. 38 is a perspective view illustrating a state in which position restriction members are separated in the stator unit;

FIG. 39A is a perspective view illustrating an appearance of a stator unit according to a sixth embodiment;

FIG. 39B is a perspective view illustrating an appearance of the stator unit according to the sixth embodiment;

FIG. 40 is a perspective view illustrating main configurations in an exploded state, in the stator unit;

FIG. 41A is a view illustrating a range in which an insulating layer is formed on an exterior of a conductor-gathered portion;

FIG. 41B is a view illustrating a range in which an insulating layer is formed on an exterior of a conductor-gathered portion; and

FIG. 42 is a view illustrating winding segments according to a modification.

### DETAILED DESCRIPTION

To begin with, examples of relevant techniques will be described. According to a comparative example, a rotary electric machine includes a field element including a magnet portion having magnetic poles whose polarities alternate in a circumferential direction, and an armature including a multiphase armature winding. When an armature has a toothless structure, positional displacement of the armature winding is concerned, unlike a configuration in which the armature winding is wound around each tooth of an armature core. Thus, for example, a restraint member may be provided to restrain the armature winding in a radial direction.

The armature winding of the armature may be fixed via molding with a resin material. In this case, since the molded resin on the armature winding may unintentionally leak out toward an air gap between the field element and the armature winding, the air gap can be expanded in advance. However, the expansion of the air gap may cause reduction in performance of the rotary electric machine.

In contrast, according to the present disclosure, a rotary electric machine is capable of holding an armature winding appropriately.

According to a first aspect of the present disclosure, a rotary electric machine includes a field element, an armature, a winding holding member, a cylindrical covering member, and a resin. The field element has magnetic poles, and the armature has a toothless structure. The armature includes a multiphase armature winding. The field element and the armature face each other in a radial direction of the rotary electric machine. The winding holding member has a cylindrical shape. The armature winding is attached to the winding holding member such that conductor portions of the armature winding are arranged in a circumferential direction of the rotary electric machine. The cylindrical covering member has a cylindrical shape and covers the conductor portions of the armature winding. The conductor portions of the armature winding are interposed between the winding holding member and the cylindrical covering member. The resin is interposed between the winding holding member and the cylindrical covering member. The cylindrical covering member covers a facing portion of the armature winding that faces the field element in the radial direction.

In the rotary electric machine including the armature having the toothless structure, a structure for fixing the armature winding may be required. In this regard, the conductor portions attached to the winding holding member are covered with the cylindrical covering member from the position opposite to the winding holding member. Accordingly, the armature winding can be fixed to the winding holding member. In particular, the resin is interposed between the winding holding member and the cylindrical covering member, and the cylindrical covering member covers the facing portion of the armature winding that faces the field element in the radial direction. In this case, the cylindrical covering member can reduce leakage of the resin interposed between the winding holding member and the cylindrical covering member beyond the cylindrical covering member in the radial direction toward the field element (i.e., leakage from a face of the cylindrical covering member facing the field element), and thereby, the cylindrical covering member can reduce adhesion of the resin to the face of the cylindrical covering member facing the field element. As a result, the armature winding can be held appropriately.

According to a second aspect of the present disclosure, the cylindrical covering member is formed of a non-magnetic material.

The cylindrical covering member is provided between the armature winding and the field element in the armature, that is, in an air gap formed in the armature. Since the cylindrical covering member is formed of the non-magnetic material, an influence of the cylindrical covering member on magnetic flux between the armature winding and the field element can be reduced, and thus an influence on performance of the rotary electric machine can be reduced.

According to a third aspect of the present disclosure, the cylindrical covering member is a long member having an elongated shape and wound around outer peripheries of the conductor portions.

The cylindrical covering member is the long member wound around the outer peripheries of the conductor portions arranged in the circumferential direction. With this configuration, a pressing force applied from the cylindrical covering member for holding the conductor portions can be easily and freely adjusted. In this case, in a state where the long member is wound, the armature winding is held in a state of being pressed toward the winding holding member. Thus, the armature winding is pressed against the winding holding member, and heat dissipation performance from the armature winding to the winding holding member can be enhanced.

The long member may have any of a string shape, a cloth shape, and a flat plate shape. The long member may be preferably wound with a uniform thickness in the radial direction at positions radially outward of the outer peripheries of the conductor portions of the armature winding.

According to a fourth aspect of the present disclosure, each of the conductor portions is formed of gathered conductor wires. Each of the conductor portions has a quadrangular shape in cross section. The resin is interposed between each of the conductor portions and the winding holding member facing each other in the radial direction.

When each of the conductor portions is formed of gathered conductor wires, and each of the conductor portions has a quadrangular shape in cross section, a gap is likely to be formed between the winding holding member and each of the conductor portions in a state where the conductor portions are attached to the cylindrical winding holding member. Thus, positional displacement or deformation of the conductor portions arranged in the circumferential direction may occur due to the formation of the gap. In this regard, since the resin is interposed between the winding holding member and each of the conductor portions facing each other in the radial direction, the gap between the winding holding member and each of the conductor portions is filled with the resin, and the positional displacement and the deformation of each conductor portion can be reduced.

According to a fifth aspect of the present disclosure, each of the conductor portions is formed of gathered conductor wires. Each of the conductor portions has a quadrangular shape in cross section. The resin is interposed between each of the conductor portions and the cylindrical covering member facing each other in the radial direction.

Since the resin is interposed between each of the conductor portions and the cylindrical covering member facing each other in the radial direction, a gap between each of the conductor portions and the cylindrical covering member is filled with the resin, and the positional displacement and the deformation of each conductor portion can be reduced. Further, since the cylindrical covering member covers the facing portion of the armature winding that faces the field element, passing of the resin across an inner face and an outer face of the cylindrical covering member in the radial direction can be suitably prevented while the positional displacement of each conductor portion can be reduced by the resin interposed between each of the conductor portions and the cylindrical covering member.

According to a sixth aspect of the present disclosure, the armature winding faces the field element in an air gap forming range. The air gap forming range is a predetermined range extending in an axial direction of the rotary electric machine. The armature winding has a first end portion that is one of opposite ends of the armature winding in the axial direction, and a second end portion that is another of the opposite ends in the axial direction. The first end portion includes a bent portion bent toward the field element in the radial direction. The cylindrical covering member extends toward the second end portion up to a boundary position of the air gap forming range, and extends toward the first end portion up to a position before another boundary position of the air gap forming range. The resin is not provided on a face of the cylindrical covering member facing the field element.

Since the armature winding includes the bent portion bent toward the field element (i.e., inward or outward) in the radial direction at the one (first end portion) of both axial ends, interference between windings can be reduced, for example, when the armature winding includes winding segments (unit coils).

For preventing the resin from adhering to the face of the cylindrical covering member facing the field element in a case where the cylindrical covering member covers the facing portion of the armature winding facing the field element, a treatment such as masking may be performed on the entire range of the face of the cylindrical covering member to which the resin is not allowed to adhere at the time of manufacturing the armature. However, since the bent portion bent toward the field element is provided in the first end portion of the armature winding, restriction may occur on the structure of the first end portion for masking, such as a seal structure provided in the manufacturing mold.

In this regard, the cylindrical covering member extends toward the second end portion up to the boundary position of the air gap forming range, and extends toward the first end portion up to the position before the other boundary position of the air gap forming range. As a result, even when the bent portion bent toward the field element is provided at the first end portion of the armature winding, the masking for preventing the resin from adhering to the face of the cylindrical covering member facing the field element can be suitably performed in the range around the first end portion.

According to a seventh aspect of the present disclosure, the rotary electric machine further includes a position restriction member that is a portion of the winding holding member or fixed to the winding holding member in a coil end of the armature. The position restriction member restricts a position of the armature winding in a state of being attached to the winding holding member.

Since the position of the armature winding is restricted by the position restriction member in the coil end, and thus holding force needed for the cylindrical covering member to hold the conductor portions is force capable of holding the conductor portions at least in the radial direction. That is, the roles of the position restriction on the armature winding in the radial direction and the other directions can be respectively allotted to the cylindrical covering member and the position restriction member. Thus, the requirement for holding force of the cylindrical covering member can be lowered, and the configuration can be simplified.

According to an eighth aspect of the present disclosure, a coil end resin portion made of resin and configured to cover a coil end of the armature. The coil end resin portion is continuous in the axial direction with the resin interposed between the winding holding member and the cylindrical covering member.

The coil end resin portion covering the coil end of the armature is axially continuous with the resin interposed between the winding holding member and the cylindrical covering member, and thus an advantageous configuration can be achieved from the viewpoint of heat dissipation performance and the viewpoint of manufacturing.

A ninth aspect of the present disclosure is a method of manufacturing a rotary electric machine. The rotary electric machine includes a field element having magnetic poles, and an armature having a toothless structure. The armature includes a multiphase armature winding. The field element and the armature are arranged to face each other in a radial direction of the rotary electric machine. The method includes attaching the armature winding to a winding holding member having a cylindrical shape to cause conductor portions of the armature winding to be arranged in a circumferential direction of the rotary electric machine. The method includes attaching a cylindrical covering member to a side of each of the conductor portions facing away from the winding holding member such that the cylindrical covering member covers a facing portion of the armature winding that faces the field element in the radial direction. The method includes filling a gap between the winding holding member and the cylindrical covering member with resin.

According to the above manufacturing method, the conductor portions attached to the winding holding member are covered with the cylindrical covering member from the position opposite to the winding holding member. Accordingly, the armature winding can be fixed to the winding holding member. The cylindrical covering member covers the facing portion of the armature winding facing the field element in the radial direction, and thereafter, the gap between the winding holding member and the cylindrical covering member is filled with the resin. In this case, the cylindrical covering member can reduce leakage of the resin beyond the cylindrical covering member in the radial direction toward the outside (i.e., leakage from a face of the cylindrical covering member facing the field element), and thereby, the cylindrical covering member can reduce adhesion of the resin to the face of the cylindrical covering member facing the field element. As a result, the armature winding can be held appropriately.

According to a tenth aspect of the present disclosure, the filling the gap includes filling a gap between the winding holding member and each of the conductor portions and a gap between each of the conductor portions and the cylindrical covering member with the resin without filling a gap between the cylindrical covering member and the field element with the resin.

According to the above manufacturing method, the resin filling can be suitably performed, while the resin is interposed in a desired position between the winding holding member and the cylindrical covering member (i.e., the gap between the winding holding member and each of the conductor portions, and the gap between each of the conductor portions and the cylindrical covering member), and while the resin is prevented from leaking out to the face of the cylindrical covering member facing away from the conductor portions (i.e., the face of the cylindrical covering member facing the field element).

A plurality of embodiments will be described with reference to the drawings. In the plurality of embodiments, functionally and/or structurally corresponding portions and/or functionally and/or structurally associated portions may be denoted by the same reference signs. For the corresponding portions and/or the associated portions, reference can be made to description of other embodiments.

A rotary electric machine in the embodiments is used as, for example, a vehicle power source. However, the rotary electric machine can be widely used for industrial use, vehicle use, aircraft use, home appliance use, office automation equipment use, game machine use, and the like. In the following embodiments, the same or equivalent portions between the embodiments are denoted by the same reference signs in the drawings, and the description of the portions denoted by the same reference signs is applied between the embodiments.

### First Embodiment

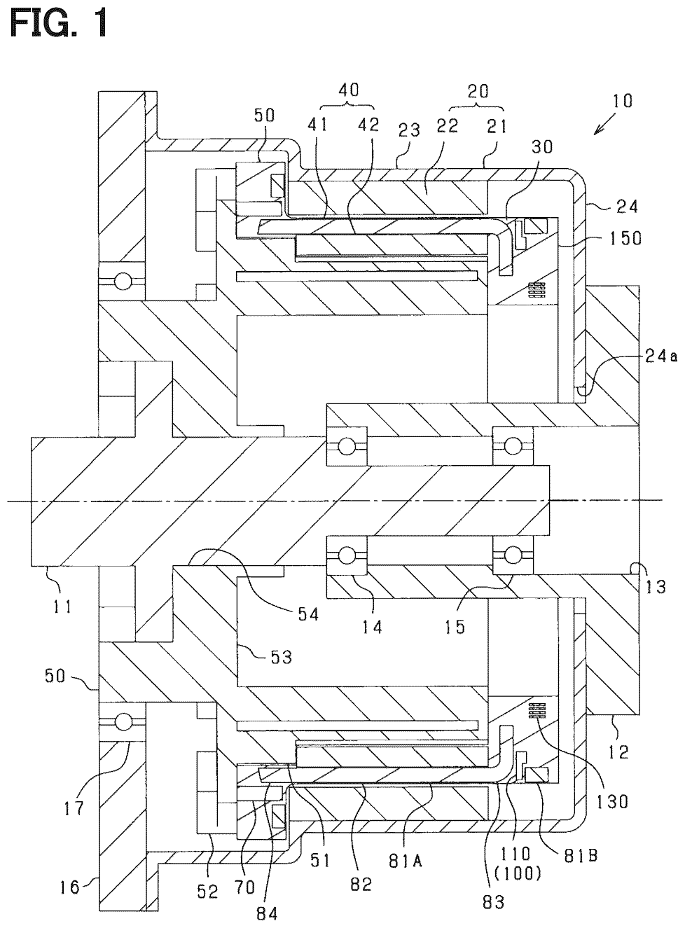

A rotary electric machine 10 according to the present embodiment is a multiphase alternating-current motor of an outer-rotor-type and a surface-magnet-type, and is used as an in-wheel motor of a vehicle. FIG. 1 is a longitudinal cross-sectional view of the rotary electric machine 10. In the following description, in the rotary electric machine 10, a direction in which a rotation axis extends is defined as an axial direction, a direction extending radially from a center of the rotation axis is defined as a radial direction, and a direction extending circumferentially around the rotation axis is defined as a circumferential direction.

The rotary electric machine 10 mainly includes a rotary electric machine main body, and the rotary electric machine main body includes a rotator 20, and a stator unit 30 including a stator 40. The rotary electric machine 10 is configured by integrating a spindle 11 having a substantially columnar shape to be fixed to a vehicle body (not illustrated) and a hub 12 to be fixed to a wheel of a vehicle wheel (not illustrated) with the rotary electric machine main body. The hub 12 includes an insertion hole 13 through which the spindle 11 is inserted. The hub 12 is rotatably supported by a pair of bearings 14, 15 in a state where the spindle 11 is inserted into the insertion hole 13 of the hub 12. In the rotary electric machine 10, the axial direction thereof is the direction in which the axis, serving as a rotation center, extends (a left-right direction in FIG. 1). The rotary electric machine 10 is attached to the vehicle such that the axial direction of the rotary electric machine 10 becomes a horizontal direction or a substantially horizontal direction.

In the rotary electric machine 10, the rotator 20 and the stator 40 are arranged to face each other in the radial direction with an air gap therebetween. The stator unit 30 is fixed to the spindle 11, and the rotator 20 is fixed to the hub 12. Thus, the hub 12 and the rotator 20 are rotatable with respect to the spindle 11 and the stator unit 30. The rotator 20 corresponds to a “field element”, and the stator 40 corresponds to an “armature”.

In a state where an integrated body of the spindle 11 and the stator unit 30 and an integrated body of the hub 12 and the rotator 20 are assembled to each other, a rotator cover 16 is fixed at one (an end around a base end of the spindle 11) of axial ends of the rotator 20. The rotator cover 16 has a circular annular plate shape. The rotator cover 16 is fixed to the rotator 20 with fasteners such as bolts, with a bearing 17 interposed between the rotator cover 16 and the stator unit 30.

The rotator 20 includes a rotator carrier 21 having a substantially cylindrical shape, and a magnet unit 22 having an annular shape and fixed to the rotator carrier 21. The rotator carrier 21 includes a cylindrical-shaped portion 23 having a cylindrical shape, and an end plate portion 24 provided on an axial one end of the cylindrical-shaped portion 23. The magnet unit 22 is fixed annularly on a radially inner face of the cylindrical-shaped portion 23. The axial other end of the rotator carrier 21 is opened. The rotator carrier 21 functions as a magnet holding member. A through-hole 24a is formed in a central portion of the end plate portion 24. In a state where the hub 12 is inserted into the through-hole 24a, the hub 12 is fixed to the end plate portion 24 with fasteners such as bolts.

The magnet unit 22 includes a plurality of permanent magnets arranged such that polarities are alternately changed along the circumferential direction of the rotator 20. With this configuration, the magnet unit 22 has a plurality of magnetic poles in the circumferential direction. The magnet unit 22 corresponds to a “magnet portion”. The permanent magnet is, for example, a sintered neodymium magnet having an intrinsic coercive force of equal to or higher than 400 [kA/m] and a residual magnetic flux density Br of equal to or higher than 1.0 [T].

The magnet unit 22 includes the plurality of permanent magnets, each of which has polar anisotropy. Each of the magnets has easy axes of magnetization whose directions are different between the vicinity of the d-axis (an area closer to the d-axis) and the vicinity of the q-axis (an area closer to the q-axis). In the vicinity of the d-axis, the direction of the easy axis of magnetization approaches a direction parallel to the d-axis, and in the vicinity of the q-axis, the direction of the easy axis of magnetization approaches a direction orthogonal to the q-axis. In this case, a magnet magnetic path is formed in an arc shape along the directions of the easy axes of magnetization. That is, each of the magnets is configured to have orientations with which the direction of the easy axis of magnetization approaches a direction parallel to the d-axis in the vicinity of the d-axis, which is a magnetic pole center, as compared with that in the vicinity of the q-axis, which is a magnetic pole boundary.

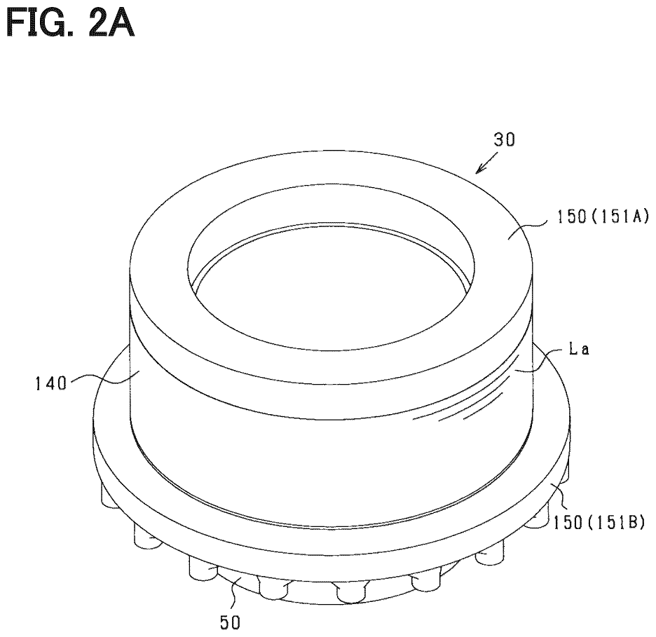

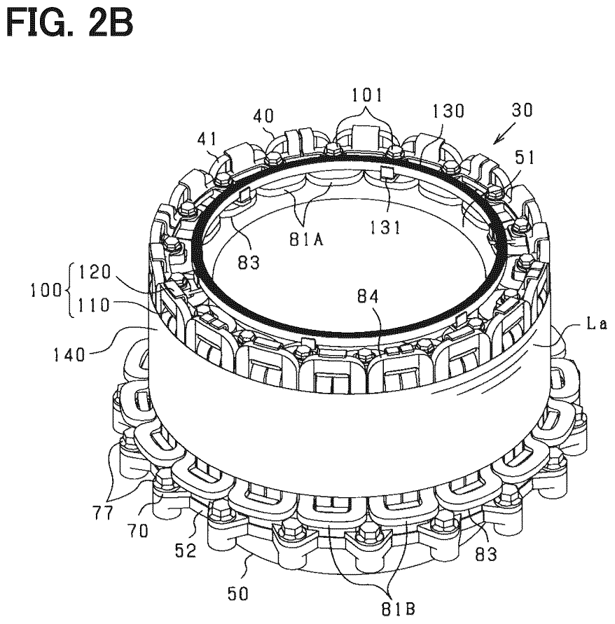

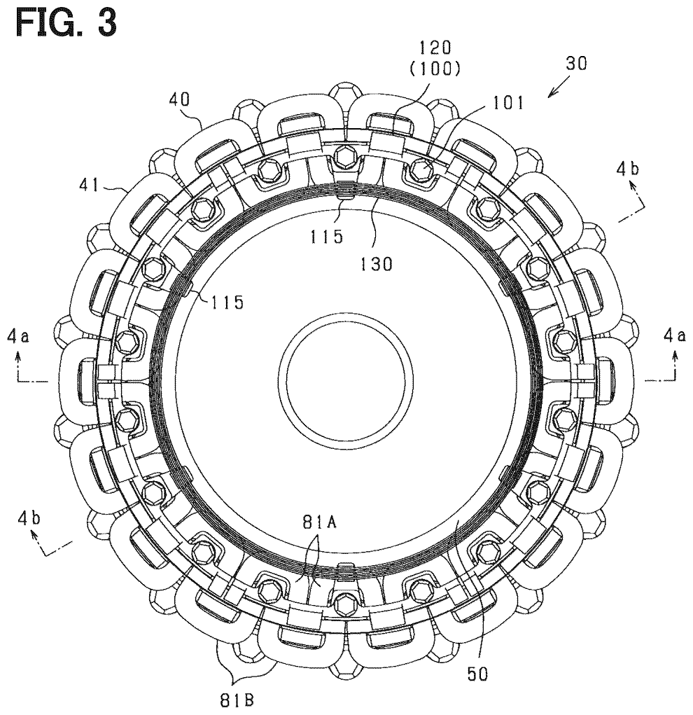

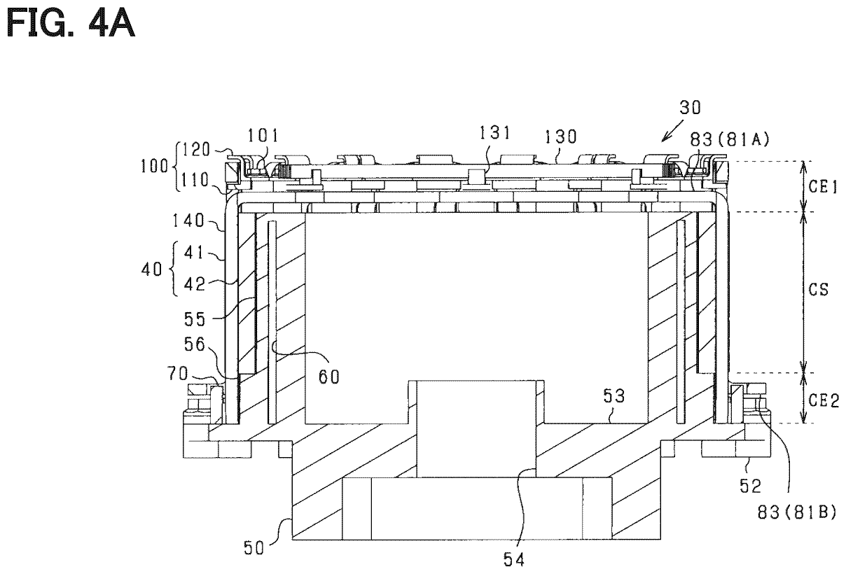

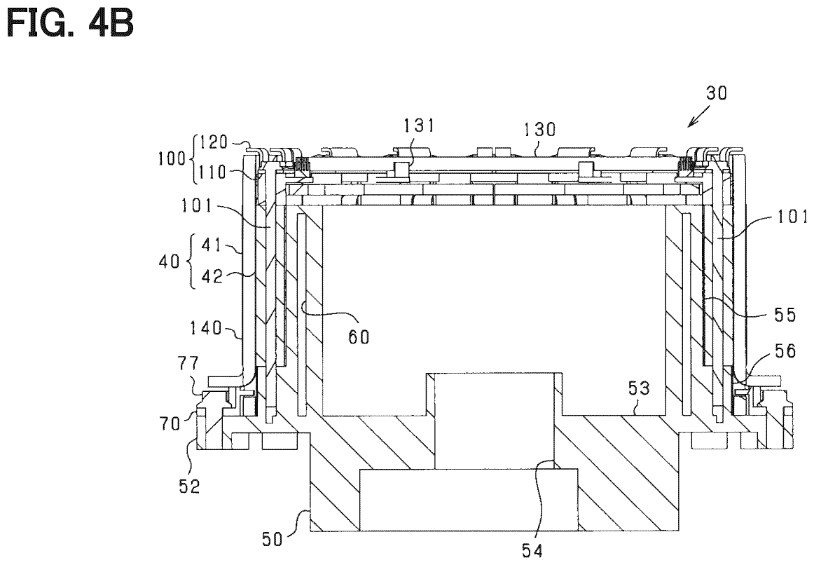

Next, a configuration of the stator unit 30 will be described. FIGS. 2A and 2B are perspective views illustrating appearances of the stator unit 30, and FIG. 2B illustrates a state in which a molded resin provided to the stator unit 30 is removed. FIG. 3 is a plan view of the stator unit 30. FIG. 4A is a cross-sectional view taken along line 4a-4a in FIG. 3, and FIG. 4B is a cross-sectional view taken along line 4b-4b in FIG. 3.

The stator unit 30 mainly includes the stator 40, a stator holder 50 provided radially inward of the stator 40, and a wiring module 130. The stator 40 has a toothless structure, and includes a stator winding 41 and a stator core 42. A configuration is made by integrating the stator core 42 and the stator holder 50 to provide these components as a core assembly CA, and by assembling a plurality of winding segments 81 forming the stator winding 41 to the core assembly CA. The stator winding 41 corresponds to an “armature winding”, the stator core 42 corresponds to an “armature core”, and the stator holder 50 corresponds to an “armature holding member”. The core assembly CA corresponds to a “winding holding member”.

The stator unit 30 has a configuration, as an external appearance thereof, where an axial one end and the axial other end of the stator unit 30 appear as a molded resin portion 150 covered with a resin, and where an entire intermediate portion of the stator unit 30 between the both axial ends appearing as the molded resin portion 150 is covered with a coil cover 140 (see FIG. 2A).

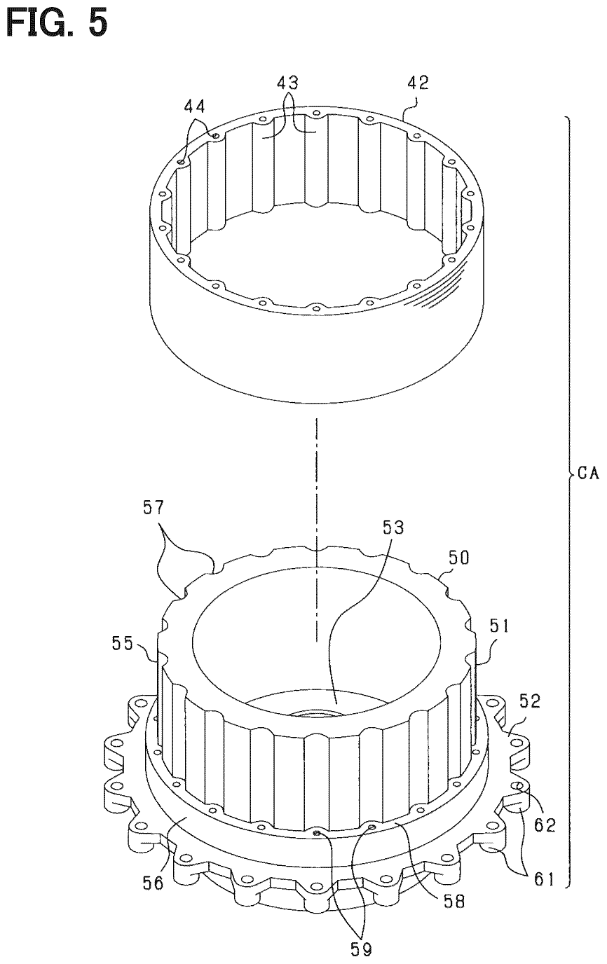

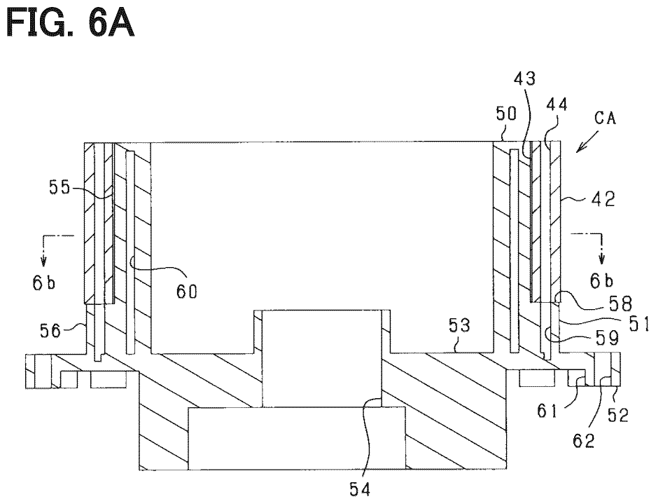

The core assembly CA will be described first. FIG. 5 is an exploded perspective view illustrating the core assembly CA. FIG. 6A is a longitudinal cross-sectional view of the core assembly CA, and FIG. 6B is a transverse cross-sectional view of the core assembly CA (a cross-sectional view taken along line 6b-6b of in FIG. 6A).

As described above, the core assembly CA includes the stator core 42, and the stator holder 50 assembled radially inward of the stator core 42. That is, the core assembly CA is configured by assembling the stator core 42 integrally to the outer peripheral face of the stator holder 50.

The stator core 42 is formed as a core-sheet laminate body in which core sheets each formed of an electromagnetic steel sheet that is a magnetic body are laminated in the axial direction. The stator core 42 has a cylindrical shape having a predetermined thickness in the radial direction. The outer peripheral face of the stator core 42, facing radially outward, has a curved face shape without unevenness, and the stator winding 41 is assembled to the outer peripheral face of the stator core 42 (that is, the face facing the rotator 20 in the radial direction). The stator core 42 functions as a back yoke. The stator core 42 is formed by, for example, axially laminating the plurality of core sheets each punched into a circular annular plate shape. However, the stator core 42 may be a stator core having a helical core structure. In the stator core 42 having a helical core structure, the stator core 42 having a cylindrical shape as a whole is formed by using a core sheet having a strip shape, and by annularly winding and axially laminating the core sheet.

In the stator core 42, a plurality of raised portions 43 is provided, on the inner peripheral face thereof facing radially inward, at predetermined intervals in the circumferential direction. Each of the raised portions 43 is a portion that locally increases the thickness in the radial direction of the stator core 42. In the portions thickened by the raised portions 43, respective through-holes 44 extending therethrough in the axial direction are formed.

In the present embodiment, the stator 40 has a slotless structure including no tooth for forming a slot, and the configuration thereof may use any of the following configurations (A) to (C). Each of the configurations (A) to (C) substantially corresponds to a toothless structure.

(A) In the stator 40, an inter-conductor member is provided between conductor portions (intermediate conductor portions 82 to be described later) in the circumferential direction. Simultaneously, a magnetic material having a relationship of Wt×Bs≤Wm×Br is used as the inter-conductor member, in a case where a width dimension in the circumferential direction of the inter-conductor member in a single magnetic pole is Wt, a saturation magnetic flux density of the inter-conductor member is Bs, a width dimension in the circumferential direction of a magnet in a single magnetic pole is Wm, and a residual magnetic flux density of the magnet is Br.

(B) In the stator 40, an inter-conductor member is provided between conductor portions (intermediate conductor portions 82) in the circumferential direction, and a non-magnetic material is used as the inter-conductor member.

(C) In the stator 40, no inter-conductor member is provided between conductor portions (intermediate conductor portions 82) in the circumferential direction.

The stator holder 50 includes a cylindrical portion 51 to which the stator core 42 is assembled, an outwardly-extending portion 52 extending radially outward with respect to the cylindrical portion 51, and a bottom portion 53 formed radially inward of the cylindrical portion 51. In the bottom portion 53, a through-hole 54 extending therethrough in the axial direction is provided, and the spindle 11 can be inserted into the through-hole 54. The stator holder 50 is formed of, for example, metal such as aluminum or cast iron, or a carbon fiber reinforced plastic (CFRP).

The cylindrical portion 51 has a two-stepped outer peripheral face, and includes a small-diameter portion 55 and a large-diameter portion 56. The stator core 42 is assembled to the small-diameter portion 55. The small-diameter portion 55 is provided with a plurality of recessed portions 57 corresponding to the raised portions 43 of the stator core 42. When the stator core 42 is assembled to the stator holder 50, the raised portions 43 of the stator core 42 are fitted onto the recessed portions 57 of the stator holder 50.

In the large-diameter portion 56, an end face 58 is formed toward the small-diameter portion 55, and a plurality of holes 59 extending in the axial direction is formed in a state of being opened to the end face 58. In the holes 59, respective internal threads are formed. In a state where the stator core 42 is assembled to the stator holder 50, the through-holes 44 in the stator core 42 and the holes 59 in the stator holder 50 communicate with each other in the axial direction. The outer diameter of the stator core 42 matches the outer diameter of the large-diameter portion 56 of the stator holder 50.

In the cylindrical portion 51, a cooling medium passage 60 through which a cooling medium such as cooling water flows is formed. The cooling medium passage 60 extends in the axial direction, and is provided annularly along the cylindrical portion 51. The cooling medium passage 60 allows the cooling medium to flow in the circumferential direction between an inlet portion and an outlet portion (not illustrated). In the present embodiment, the plurality of recessed portions 57 is provided in the small-diameter portion 55 as described above, and thus the cooling medium passage 60 is formed such that the cooling medium passage 60 is recessed radially inward for each of the recessed portions 57. However, the cooling medium passage 60 need not be recessed for each of the recessed portions 57, and may be formed in a completely annular shape in which no recess is formed.

The cylindrical portion 51 preferably has a double structure including a radially outer cylindrical member and a radially inner cylindrical member to form the cooling medium passage 60 by using a gap space between the outer cylindrical member and the inner cylindrical member. Although not illustrated, an external circulation path for circulating the cooling medium is connected to the cooling medium passage 60. The external circulation path is provided with, for example, an electric pump, and a heat dissipation device such as a radiator. With the driving of the pump, the cooling medium circulates through the circulation path and the cooling medium passage 60 of the rotary electric machine 10.

The outwardly-extending portion 52 is provided with a plurality of protruding portions 61 at predetermined intervals in the circumferential direction. In the protruding portions 61, respective through-holes 62 extending therethrough in the axial direction are formed. In the through-holes 62, respective internal threads are formed. The number of provided raised portions 43 (the number of provided through-holes 44) of the stator core 42 and the number of provided protruding portions 61 are the same, and the number is, for example, 18 in the present embodiment.

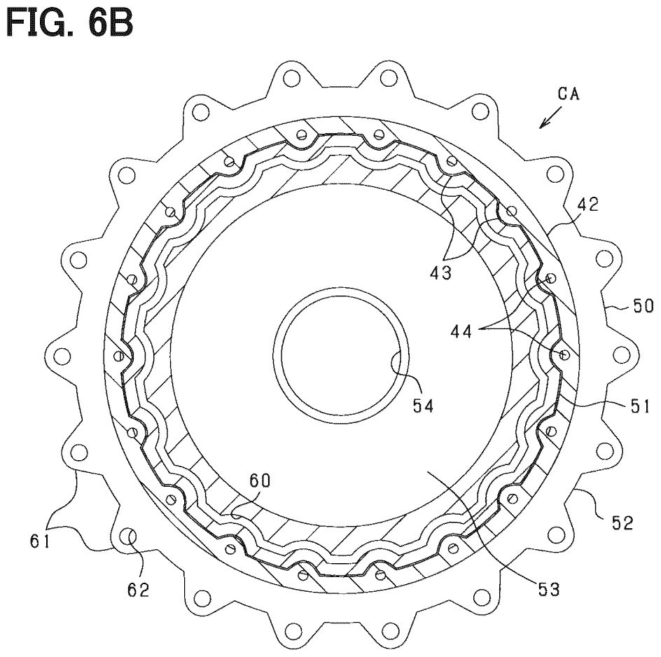

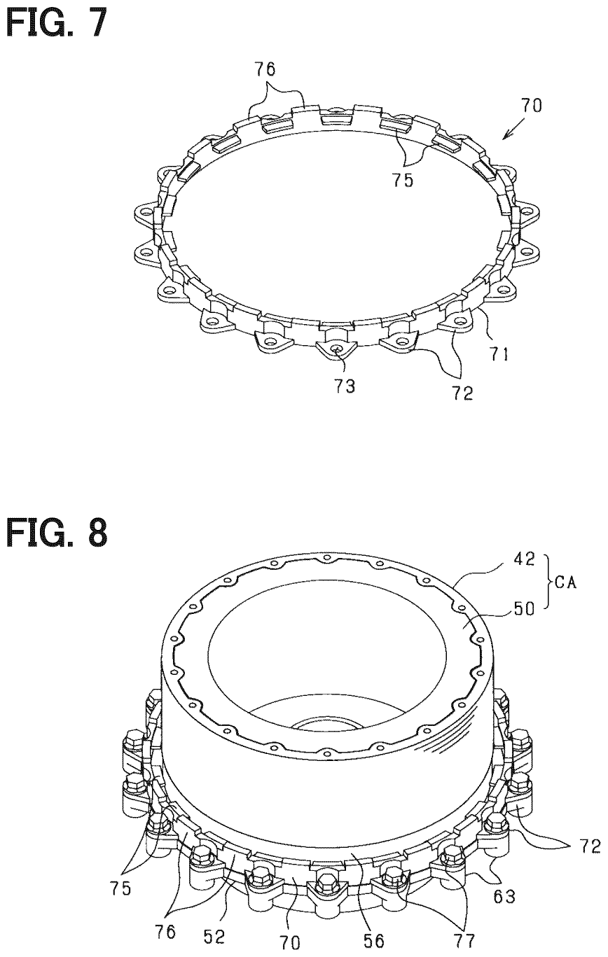

A position restriction member 70 that restricts the positions of the winding segments 81 assembled to the core assembly CA is configured to be fixed to the outwardly-extending portion 52 of the stator holder 50 (see FIG. 2B). FIG. 7 is a perspective view of the position restriction member 70, and FIG. 8 is a perspective view illustrating a state in which the position restriction member 70 is assembled to the core assembly CA.

The position restriction member 70 includes a circular annular portion 71 having a diameter larger than the diameter of the large-diameter portion 56 of the stator holder 50. A plurality of protruding portions 72 protruding radially outward is provided on the circular annular portion 71. The protruding portions 72 are provided at predetermined intervals in the circumferential direction. The positions of the protruding portions 72 match the positions of the protruding portions 61 provided in the outwardly-extending portion 52 of the stator holder 50. In the protruding portions 72, respective through-holes 73 extending therethrough in the axial direction are formed.

Restriction portions 75, 76 that restrict positions of crossover portions (crossover portions 83, 84 to be described later) of the winding segments 81 assembled to the core assembly CA are provided on the circular annular portion 71.

The restriction portions 75 are provided at predetermined intervals in the circumferential direction to extend radially inward from the circular annular portion 71. The restriction portions 76 are provided at predetermined intervals in the circumferential direction to extend axially from the circular annular portion 71. The restriction portions 75, 76 are projecting portions extending in the circumferential direction, and are provided to be arranged alternately in the circumferential direction.

The position restriction member 70 is a member that has a function of restricting the positions of the winding segments 81, and is desirably a member having high rigidity. In the present embodiment, the position restriction member 70 is formed of metal. Specifically, the position restriction member 70 in the present embodiment is formed of, for example, aluminum, an aluminum alloy, cast iron, or the like.

In FIG. 8, the position restriction member 70 is assembled to the outwardly-extending portion 52 of the stator holder 50. That is, bolts 77 serving as fasteners are screwed into the protruding portions 61 in the outwardly-extending portion 52 and the protruding portions 72 in the position restriction member 70, whereby the position restriction member 70 is fixed to the core assembly CA. In this state, the large-diameter portion 56 of the stator holder 50 and the position restriction member 70 face each other in the radial direction to form an annular space therebetween. The positions of the winding segments 81 are restricted by the annular space and the restriction portions 75, 76 of the position restriction member 70. However, details thereof will be described later.

An annular inner space is formed inward of the inner periphery of the cylindrical portion 51, and a configuration may be made in which, for example, an electric component forming an inverter serving as an electric power converter is disposed in the inner space. The electric component is, for example, an electric module in which a semiconductor switching element or a capacitor is packaged. By disposing the electric module in contact with the inner peripheral face of the cylindrical portion 51, the electric module can be cooled by the cooling medium flowing through the cooling medium passage 60.

Next, the configuration of the stator winding 41 assembled to the core assembly CA will be described in detail. A state in which the stator winding 41 is assembled to the core assembly CA is as illustrated in FIGS. 2 to 14. The plurality of winding segments 81 forming the stator winding 41 is assembled, in a state of being arranged in the circumferential direction, radially outward of the core assembly CA, that is, radially outward of the stator core 42. The stator winding 41 includes a plurality of phase windings, and is formed in a cylindrical shape (annular shape) by arranging the plural-phase windings in a predetermined order in the circumferential direction. In the present embodiment, the stator winding 41 includes three phase windings by using the U-phase, V-phase, and W-phase windings.

As illustrated in FIG. 4A, the stator 40 includes, in the axial direction, portions corresponding to a coil side CS radially facing the stator core 42, and portions corresponding to coil ends CE1, CE2 located at axially outer positions with respect to the coil side CS. The coil side CS is also a portion facing the magnet unit 22 of the rotator 20 in the radial direction. In this case, the winding segments 81 are assembled in a state where both axial end portions thereof protrude outward in the axial direction (that is, toward the coil ends CE1, CE2) with respect to the stator core 42. The winding segments 81 are provided in accordance with the number of poles of the rotary electric machine 10, and a plurality of winding segments 81 is connected in parallel or in series for each phase. In the present embodiment, the number of magnetic poles is 24, but the number of magnetic poles may be set to an appropriate number.

Each of the winding segments 81 is provided such that a first one of both axial ends is bent in the radial direction and a second one of both axial ends is unbent in the radial direction. Half of the winding segments 81 out of all the winding segments 81 each are configured such that a portion in the axial one end range is formed as a bent portion and this bent portion is bent radially inward. The remaining half of the winding segments 81 each are configured such that a portion in the axial other end range is formed as a bent portion and this bent portion is bent radially outward. In the following description, among the winding segments 81, the winding segment 81 including the bent portion bent radially inward is also referred to as a “winding segment 81A”, and the winding segment 81 including the bent portion bent radially outward is also referred to as a “winding segment 81B”.

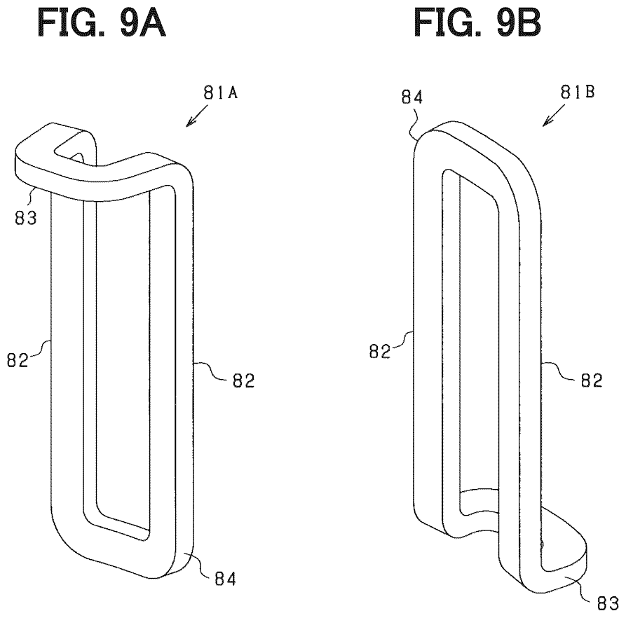

The configurations of the winding segments 81A, 81B will be described in detail. FIGS. 9A and 9B are perspective views illustrating respective configurations of the winding segments 81A, 81B.

Each of the winding segments 81A, 81B is formed by winding a conductor wire a plurality of times, and includes a pair of intermediate conductor portions 82 and a pair of crossover portions 83, 84. The pair of intermediate conductor portions 82 are provided in parallel to each other, and have a linear shape. The pair of crossover portions 83, 84 connect the pair of intermediate conductor portions 82 at both axial ends. Each of the winding segments 81A, 81B is formed in an annular shape by the pair of intermediate conductor portions 82 and the pair of crossover portions 83, 84. The pair of intermediate conductor portions 82 are provided to be separated from each other by a distance of a predetermined coil pitch. Thus, between the pair of intermediate conductor portions 82, an intermediate conductor portion 82 of a winding segment 81 of another phase can be arranged, in the circumferential direction. In the present embodiment, the pair of intermediate conductor portions 82 are provided to be separated from each other by a distance of two coil pitches. Thus, between the pair of intermediate conductor portions 82, intermediate conductor portions 82 of winding segments 81 of the other two phases are configured to be arranged one by one. In a state where the winding segments 81A, 81B are arranged in the circumferential direction, respective intermediate conductor portions 82 of winding segments 81A, 81B different from each other are arranged in the circumferential direction in a state close to each other.

Regarding the crossover portions 83, 84 in both axial end ranges, the crossover portion 83 is provided as a portion corresponding to the coil end CE1 or the coil end CE2 and the crossover portion 84 is provided as a portion corresponding to the coil end CE1 or the coil end CE2 (see FIG. 4A). Of the crossover portions 83, 84, the crossover portion 83 is formed to be bent in the radial direction, and the crossover portion 84 opposite to the crossover portion 83 is formed without being bent in the radial direction. The crossover portion 83 is a “bent crossover portion”, and the crossover portion 84 is an “unbent crossover portion”. The crossover portion 83 is provided to be bent in a direction orthogonal to a direction in which the intermediate conductor portion 82 extends, that is, in a direction orthogonal to the axial direction. Thus, each of the winding segments 81A, 81B has a substantially L-shape when laterally viewed.

In the winding segments 81A, 81B, bent directions of the respective crossover portions 83 in the radial direction are different. That is, in the winding segment 81A, the crossover portion 83 is bent inward in the radial direction. In the winding segment 81B, the crossover portion 83 is bent outward in the radial direction. When an arrangement of the winding segments 81A, 81B in the circumferential direction in this case is assumed, respective shapes in plan view (planar shapes in the radial direction) of the crossover portions 83 in the winding segments 81A, 81B are preferably different from each other. In the crossover portion 83 of the winding segment 81A, a width thereof in the circumferential direction is preferably narrowed toward a tip end. In the crossover portion 83 of the winding segment 81B, a width thereof in the circumferential direction is preferably widen toward a tip end.

In FIG. 4A, the crossover portion 83 of the winding segment 81A is bent radially inward in the range of the coil end CE1 (upper in the drawing) that is the one end range of both axial end ranges, and the crossover portion 83 of the winding segment 81B is bent radially outward in the range of the coil end CE2 (lower in the drawing) that is the other end range.

In the winding segments 81A, 81B, the intermediate conductor portions 82 are provided as coil side conductor portions arranged one by one in the circumferential direction, in the coil side CS. The crossover portions 83, 84 are provided as coil end conductor portions connecting the same phase intermediate conductor portions 82 at two different positions in the circumferential direction, in the coil ends CE1, CE2.

Each of the winding segments 81A, 81B is formed by winding a conductor wire a plurality of times such that the cross section of a conductor-gathered portion has a quadrangular shape. In the intermediate conductor portion 82, conductor wires are arranged to form multiple columns in the circumferential direction and multiple columns in the radial direction, whereby the intermediate conductor portion 82 is formed to have a transverse cross section with a substantially rectangular shape. In the present embodiment, a rectangular wire having a rectangular cross-sectional shape is used as the conductor wire, and the rectangular wire is wound a plurality of times to form each of the winding segments 81A, 81B.

As described above, in the state where the winding segments 81 are assembled to the core assembly CA, the positions of the winding segments 81 are restricted by the position restriction member 70 in the range of the coil end CE2 (lower in FIG. 4A). In the range of the coil end CE1 (upper in FIG. 4A), the positions of the winding segments 81 are restricted by a position restriction member 100, which is a member different from the position restriction member 70. That is, the position of each of the winding segments 81 is restricted by the position restriction member 70 at the end where the crossover portion 83 is bent radially outward (the range of CE2) of both axial ends, whereas the position of each of the winding segments 81 is restricted by the position restriction member 100 at the end where the crossover portion 83 is bent radially inward (the range of CE1).

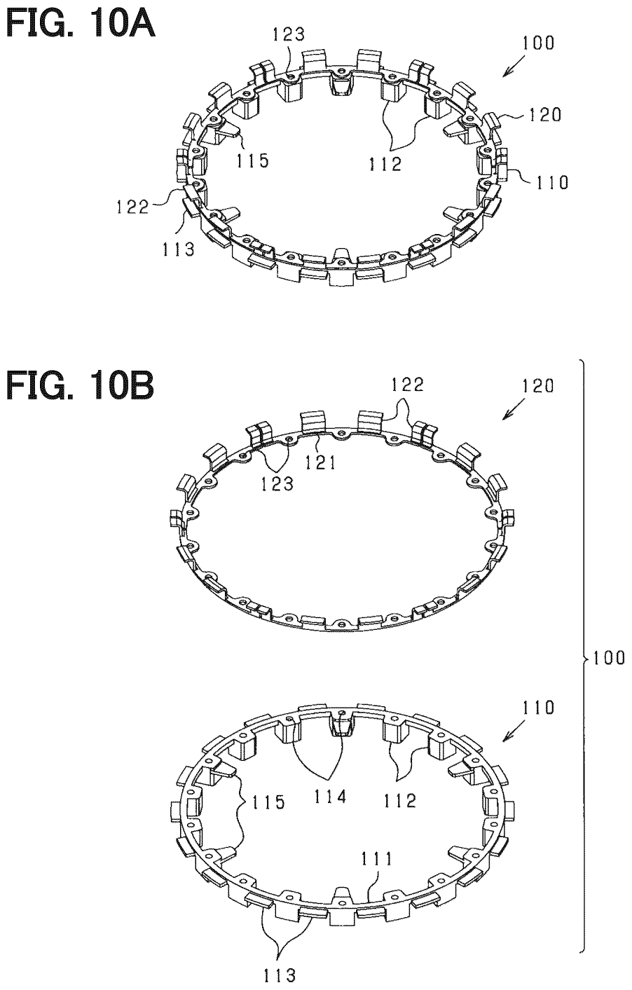

Hereinafter, the configuration of the position restriction member 100 will be described. FIG. 10A is a perspective view of the position restriction member 100, and FIG. 10B is a perspective view illustrating a state in which a first annular member 110 and a second annular member 120 forming the position restriction member 100 are separated from each other. The position restriction member 100 includes the first annular member 110 and the second annular member 120, which are formed in respective annular shapes and provided in an axially overlapping state. The first annular member 110 is provided in a state of being in contact with an axial end face of the stator core 42. The second annular member 120 is provided at a position opposite to the stator core 42 across the first annular member 110, in the axial direction. In the range of the coil end CE1, the positions of the winding segments 81 are restricted by the position restriction member 100 including the first annular member 110 and the second annular member 120, which are separable from each other.

Like the position restriction member 70, each of the annular members 110, 120 is a member that has a function of restricting the positions of the winding segments 81, and is desirably a member having high rigidity. In the present embodiment, each of the annular members 110, 120 is formed of metal. Specifically, each of the annular members 110, 120 in the present embodiment is formed of, for example, aluminum, an aluminum alloy, cast iron, or the like.

As illustrated in FIG. 10B, the first annular member 110 includes a circular annular portion 111, and restriction portions 112, 113 provided on the circular annular portion 111 at respective predetermined intervals. The restriction portions 112 are provided to extend axially from the circular annular portion 111, whereas the restriction portions 113 are provided to extend radially outward from the circular annular portion 111. These restriction portions 112, 113 are provided to be arranged alternately in the circumferential direction. In the restriction portions 112, respective through-holes 114 extending therethrough in the axial direction are formed. Among the plurality of restriction portions 112 arranged in the circumferential direction, some restriction portions 112 are provided with protruding portions 115 protruding radially inward.

The second annular member 120 includes a circular annular portion 121, and restriction portions 122 provided on the circular annular portion 121 at predetermined intervals. The restriction portions 122 are provided to extend axially from the circular annular portion 121, and are further bent radially outward in respective tip end ranges of the restriction portions 122. In the circular annular portion 121, through-holes 123 extending therethrough in the axial direction are formed.

As illustrated in FIG. 10A, in a state where the first annular member 110 and the second annular member 120 are integrated, the respective circular annular portions 111, 121 of the annular members 110, 120 overlap with each other, whereby the respective through-holes 114, 123 of the annular members 110, 120 are brought into a state where the through-holes 114 communicate with the through-holes 123 in the axial direction. The restriction portions 113 of the first annular member 110 face the restriction portions 122 of the second annular member 120 in a state where the restriction portions 113 are separated from the restriction portions 122 in the axial direction (upper-lower direction in the drawing).

To reduce mutual positional displacement in a state where the annular members 110, 120 overlap with each other, at least one of the annular members 110, 120 is preferably provided with an engagement portion enabling, for example, projection-recess engagement. As a result, the positional displacement is reduced in the annular members 110, 120 at the time of assembling the annular members 110, 120 to the core assembly CA.

The position restriction member 100 (the first annular member 110 and the second annular member 120) is configured to be fixed to the core assembly CA with long bolts 101. Specifically, as illustrated in each of in FIGS. 4A and 4B, the position restriction member 100 is assembled to the axial end face of the stator core 42. In the assembled state, the respective through-holes 114, 123 of the annular members 110, 120, the through-holes 44 of the stator core 42, and the holes 59 of the stator holder 50 communicate with one another in the axial direction. By screwing the long bolts 101 into the series of holes, the position restriction member 100 is fixed to the core assembly CA.

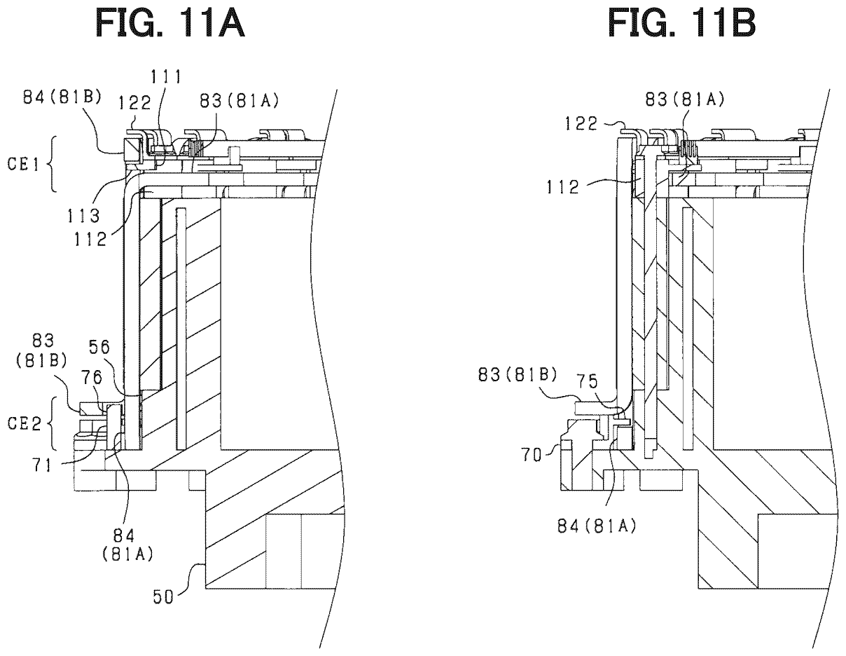

The outline of the position restriction for the winding segments 81A, 81B made by the position restriction members 70, 100 will be described with reference to FIGS. 11A and 11B. In FIGS. 11A and 11B are enlarged views illustrating parts of FIGS. 4A and 4B, and FIG. 11A corresponds to FIG. 4A and FIG. 11B corresponds to FIG. 4B.

As illustrated in each of in FIGS. 11A and 11B, in the range of the coil end CE2, the circular annular portion 71 of the position restriction member 70 and the large-diameter portion 56 of the stator holder 50 face each other in the radial direction to form the annular space therebetween. The crossover portions 84 (unbent crossover portions) of the winding segments 81A are inserted into the annular space. As a result, the radial and axial positions of the winding segments 81A are restricted in the range of the coil end CE2. Each of the restriction portions 75 of the position restriction member 70 is placed at a position annularly inward with respect to a corresponding one of the crossover portions 84 of the winding segments 81A, whereby the circumferential and axial positions of the winding segments 81A are restricted in the range of the coil end CE2.

Each of the restriction portions 76 of the position restriction member 70 is placed at a position annularly inward with respect to a corresponding one of the crossover portions 83 (bent crossover portions) of the winding segments 81B, whereby the circumferential positions of the winding segments 81B are restricted in the range of the coil end CE2.

On the other hand, in the range of the coil end CE1, the axial positions of the winding segments 81A are restricted by the circular annular portion 111 of the first annular member 110. Each of the restriction portions 112 of the first annular member 110 is placed at a position annularly inward with respect to a corresponding one of the crossover portions 83 of the winding segments 81A, whereby the circumferential and radial positions of the winding segments 81A are restricted in the range of the coil end CE1.

Each of the crossover portions 84 of the winding segments 81B is arranged between a corresponding one of the restriction portions 113 of the first annular member 110 and a corresponding one of the restriction portions 122 of the second annular member 120, whereby the circumferential and axial positions of the winding segments 81B are restricted in the range of the coil end CE1. Each of the position restriction members 70, 100 is provided as a common member that commonly restricts both the positions of the winding segments 81A, 81B.

Next, the wiring module 130 will be described. The wiring module 130 is a winding connection member electrically connected to the winding segments 81A, 81B, in the stator winding 41. By the wiring module 130, the plural-phase winding segments 81 are connected in parallel or in series for each phase, and the plural-phase windings are connected at a neutral point. As illustrated in each of in FIGS. 4A and 4B, the wiring module 130 is provided in the range of the coil end CE1, that is, in the one end range of both axial end ranges where the crossover portions 83 of the winding segments 81A are bent radially inward.

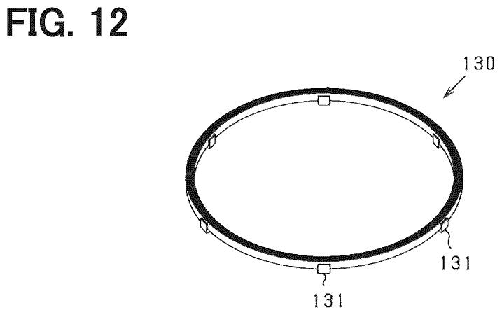

As illustrated in FIG. 12, the wiring module 130 is formed in a circular annular shape, and a plurality of pedestal portions 131 is provided at predetermined intervals in the circumferential direction. The wiring module 130 is fixed to the position restriction member 100. Specifically, the pedestal portions 131 are fixed to the protruding portions 115 (see FIG. 10A) provided in the first annular member 110, whereby the wiring module 130 is fixed to the position restriction member 100. In the range of the coil end CE1, the crossover portions 84 of the winding segments 81B are annularly arranged, and the wiring module 130 is provided radially inward of the crossover portions 84 of the winding segments 81B.

Although a detailed configuration is omitted, the wiring module 130 includes, for respective phases, wiring members such as bus bars, and each of the wiring members is connected to a corresponding phase one of electric power input and output lines. Then, the plural-phase electric power input and output lines are connected to an inverter (not illustrated) to allow electric power to be input and output. A current sensor that detects the phase current of each phase may be integrally provided in the wiring module 130. The wiring module 130 is simply required to be formed in an annular shape in accordance with the form of the stator winding 41. Thus, the wiring module 130 may have a polygonal annular shape, or a substantially C-shape in which a part of the annular shape is missing.

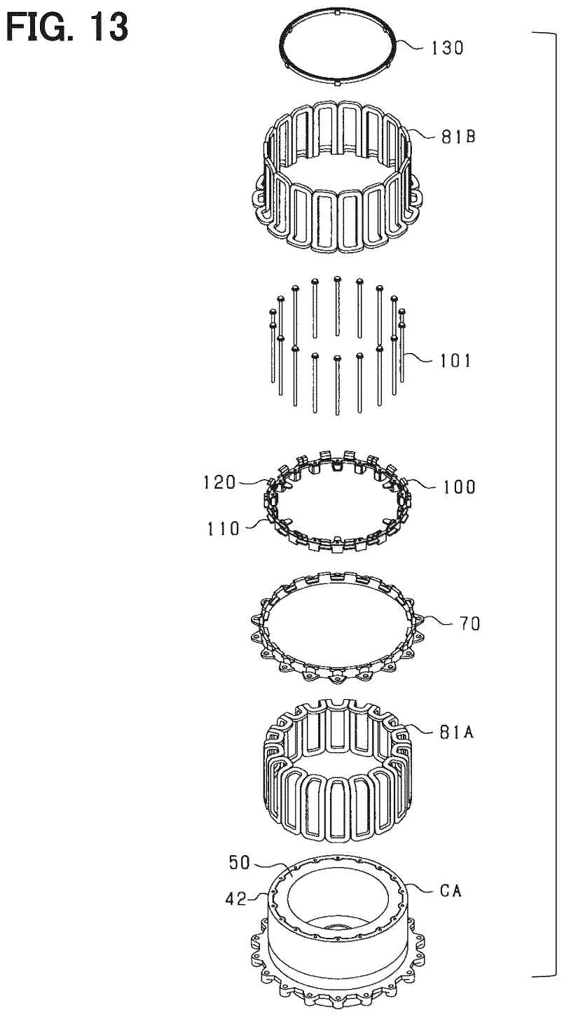

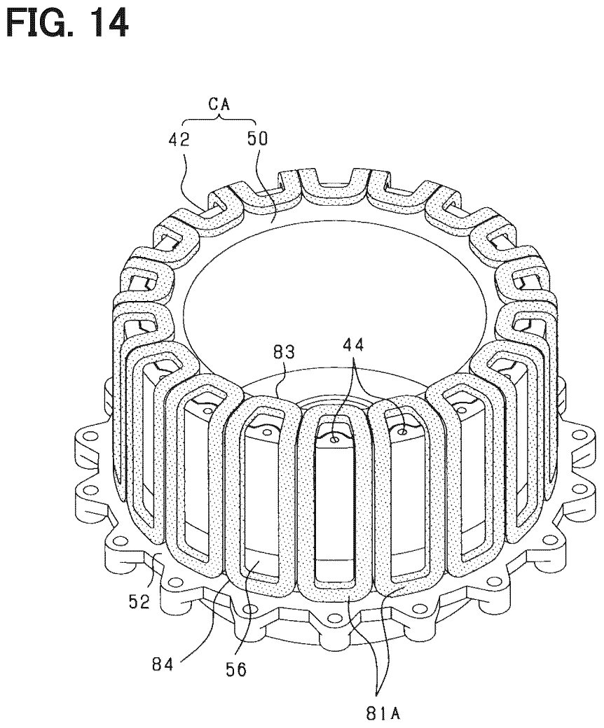

Next, an assembling procedure of the members in the stator unit 30 and specific configurations of the details of the stator unit 30 will be described. FIG. 13 is an exploded perspective view of the stator unit 30 disassembled in an assembling order. In FIG. 13, the stator unit 30 is illustrated in an exploded state of being disassembled into the core assembly CA, the winding segments 81A, the position restriction members 70, 100, the winding segments 81B, and the wiring module 130. FIGS. 14 to 17 are perspective views illustrating configurations in the assembling processes of the stator unit 30.

In the assembling of the stator unit 30, first, the plurality of winding segments 81A is assembled to the core assembly CA, in FIG. 14. In this state, in the range of the coil end CE1 (upper in the drawing), the crossover portions 83 (bent crossover portions) of the winding segments 81A are arranged to face the axial end face of the stator core 42. In this case, each of the winding segments 81A is arranged while a corresponding one of the through-holes 44 of the stator core 42 is set as a circumferential center position of the arrangement. In the range of the coil end CE2 (lower in the drawing), the crossover portions 84 (unbent crossover portions) of the winding segments 81A are in a state of facing an axial end face of the outwardly-extending portion 52 of the stator holder 50 and being arranged in the circumferential direction along the large-diameter portion 56.

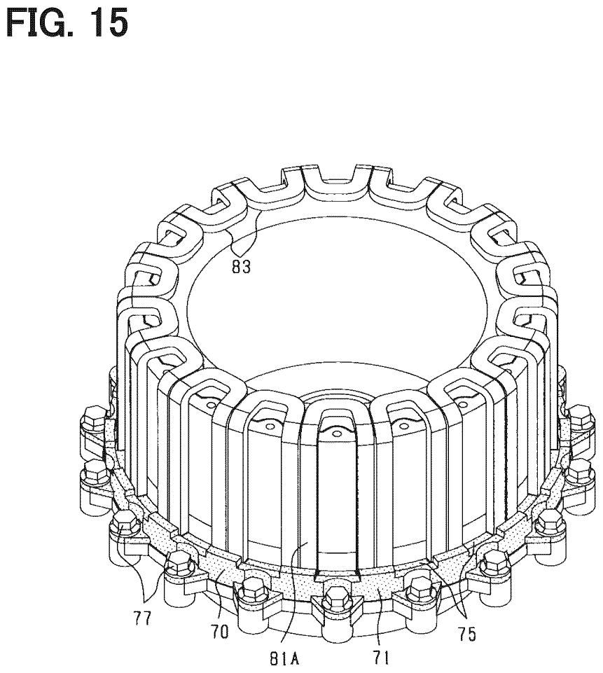

In FIG. 15, the position restriction member 70 in the range of the coil end CE2 is assembled to the assembly in the state of FIG. 14. At this time, the position restriction member 70 is assembled from above in the axial direction, and the position restriction member 70 is fixed to the core assembly CA by screwing the bolts 77. In this state, the crossover portions 84 of the winding segments 81A are in a state of being placed between the circular annular portion 71 of the position restriction member 70 and the large-diameter portion 56 of the stator holder 50, and the radial positions of the winding segments 81A are restricted in the range of the coil end CE2. Each of the restriction portions 75 of the position restriction member 70 is placed between a corresponding one pair of the pairs of intermediate conductor portions 82 of the winding segments 81A to axially face a tip end portion of a corresponding one of the crossover portions 84 of the winding segments 81A, whereby the circumferential and axial positions of the winding segments 81A are restricted in the range of the coil end CE2.

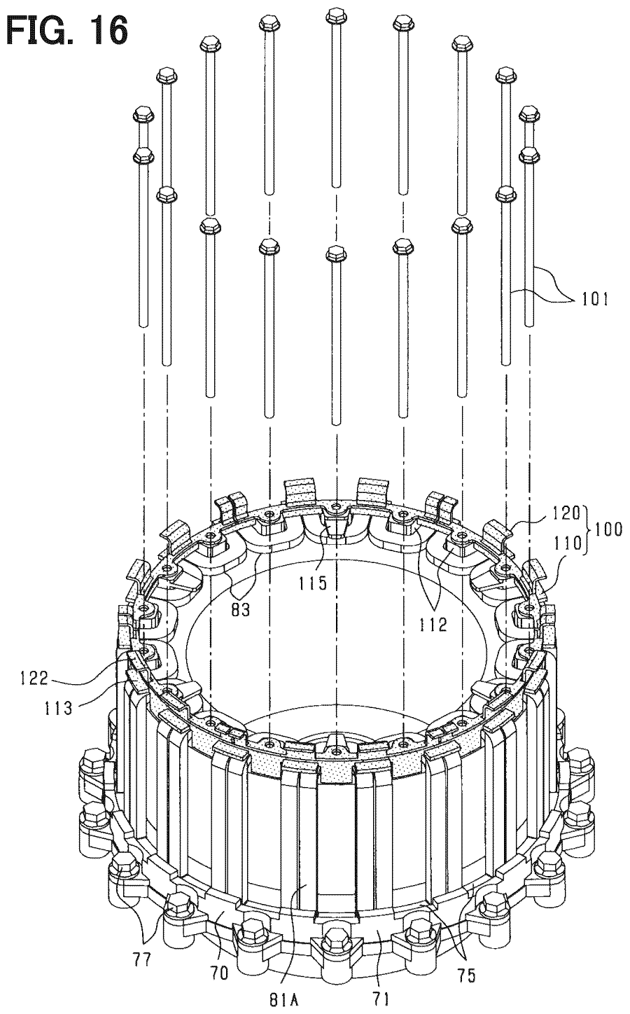

In FIG. 16, the position restriction member 100 in the range of the coil end CE1 is assembled to the assembly in the state of FIG. 15. The annular members 110, 120 of the position restriction member 100 are assembled from an axially outer position with respect to the crossover portions 83 of the winding segments 81A, and are fixed to the core assembly CA by screwing the long bolts 101. In this state, the axial positions of the winding segments 81A are restricted by the circular annular portion 111 of the first annular member 110. Each of the restriction portions 112 of the first annular member 110 is placed at a position annularly inward with respect to a corresponding one of the crossover portions 83 of the winding segments 81A, whereby the circumferential and radial positions of the winding segments 81A are restricted in the range of the coil end CE1.

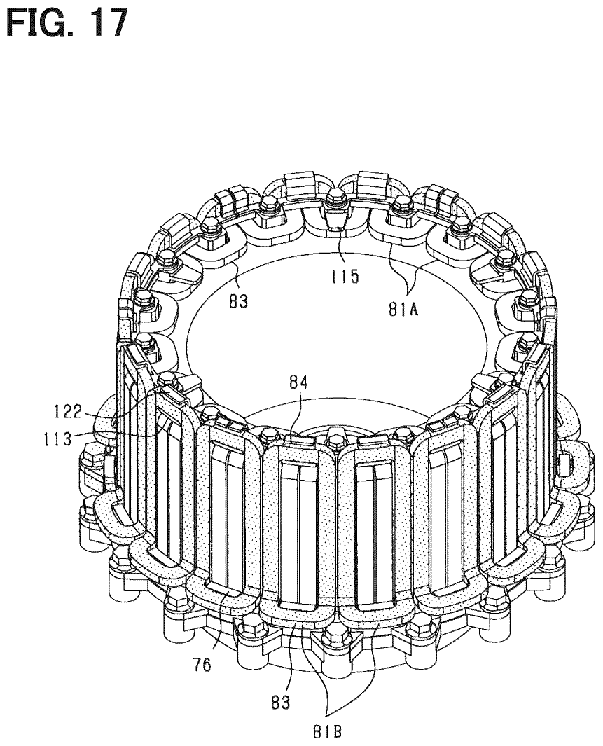

In FIG. 17, the plurality of winding segments 81B is assembled to the assembly in the state of FIG. 16. At this time, the winding segments 81B are assembled from radially outside such that each of the intermediate conductor portions 82 of the winding segments 81B is placed between corresponding ones of the intermediate conductor portions 82 of the winding segments 81A. In this state, each of the restriction portions 76 of the position restriction member 70 is placed at a position annularly inward with respect to a corresponding one of the crossover portions 83 of the winding segments 81B, whereby the circumferential positions of the winding segments 81B are restricted in the range of the coil end CE2. Each of the crossover portions 84 of the winding segments 81B is arranged between a corresponding one of the restriction portions 113 of the first annular member 110 and a corresponding one of the restriction portions 122 of the second annular member 120, whereby the circumferential and axial positions of the winding segments 81B are restricted in the range of the coil end CE1.

Then, the wiring module 130 is assembled to the assembly in the state of FIG. 17 (see FIG. 2B).

As illustrated in FIG. 2B, the coil cover 140 formed in a circular annular shape is attached radially outward of the winding segments 81A, 81B, as a restraint member that restrains the winding segments 81A, 81B. The coil cover 140 is a cylindrical covering member that has a cylindrical shape and covers the winding segments 81A, 81B arranged in the circumferential direction from radially outside, that is, from a position opposite to the core assembly CA. The coil cover 140 is provided to cover the entire facing portion, in the stator winding 41, facing the magnet unit 22 of the rotator 20 in the radial direction, that is, the entirety of a range including at least the coil side CS. In other words, the coil side CS of the stator winding 41 is configured to be covered with the coil cover 140 without a gap.

The coil cover 140 is a long member La that is a non-magnetic body and that has an elongated shape, and the long member La is wound around the outer periphery of each of the winding segments 81A, 81B. More specifically, the long member La includes a core material and an impregnation material with which the core material is impregnated, and has an elongated shape. The long material La is wound spirally around the outer peripheries of the winding segments 81A, 81B, and parts of the impregnation material are bonded to each other in the axial direction, thereby forming the coil cover 140. For example, the long material La is a so-called prepreg, the core material is a fibrous material such as carbon fiber, glass fiber, or aramid fiber, and the impregnation material is an insulating resin such as a thermosetting resin (epoxy resin).

The long material La may be a long material having any of a string shape, a cloth shape, and a band shape. The long material La is preferably wound with a uniform thickness in the radial direction at a position radially outward of the outer periphery of each of the winding segments 81A, 81B.

As illustrated in FIG. 2A, in the stator unit 30 of the present embodiment, resin-molding is performed in a range including the coil ends CE1, CE2 in both axial end ranges.

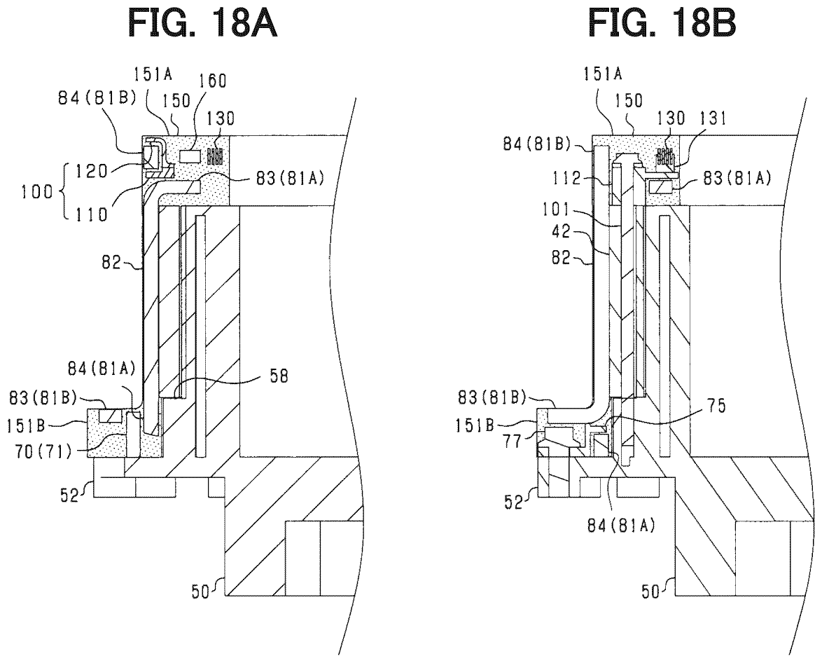

Hereinafter, a configuration related to the molded resin on the stator unit 30 will be described. FIGS. 18A and 18B are cross-sectional views each illustrating the stator unit 30 in a state where the molded resin portion 150 is added. Note that FIG. 18A corresponds to FIG. 4A, and FIG. 18B corresponds to FIG. 4B.

The molded resin portion 150 is provided to cover a range from the position restriction member 70, which is the position restriction member in the axial one end range, to the position restriction member 100 in the axial other end range, inclusive, and to cover a range including the periphery of the intermediate conductor portions 82 of the winding segments 81A, 81B, in the axial direction. Here, in the molded resin portion 150 as a resin layer, a portion that resin-seals each of the coil ends CE1, CE2 is configured as a coil end resin portion 151, and a portion that resin-seals the coil side CS is configured as a coil side resin portion 152. For convenience of description, in the coil end resin portion 151 provided in each of both axial end ranges, a portion in the range of the coil end CE1 is referred to as a coil end resin portion 151A, and a portion in the range of the coil end CE2 is referred to as a coil end resin portion 151B.

In the coil end CE1, an insulating layer is formed between each of the winding segments 81A, 81B and the position restriction member 100 by the coil end resin portion 151, while in the coil end CE2, an insulating layer is formed between each of the winding segments 81A, 81B and the position restriction member 70 by the coil end resin portion 151. That is, in the coil end CE1, each of the crossover portions 83, 84 of the winding segments 81A, 81B and the position restriction member 100 are arranged in a state of being separated slightly from each other, and the coil end resin portion 151A is formed as the insulating layer by filling with a resin in a range including part formed by the separation. In the coil end CE2, each of the crossover portions 83, 84 of the winding segments 81A, 81B and the position restriction member 70 are arranged in a state of being separated slightly from each other, and the coil end resin portion 151B is formed as the insulating layer in a range including part formed by the separation.

In the coil side CS, the coil side resin portion 152 is formed as an insulating layer by filling with a resin, around each of the intermediate conductor portions 82 arranged in the circumferential direction. That is, the resin of the coil side resin portion 152 is configured to be interposed between the stator core 42 and the coil cover 140. Hereinafter, the coil side resin portion 152 will be described in detail.

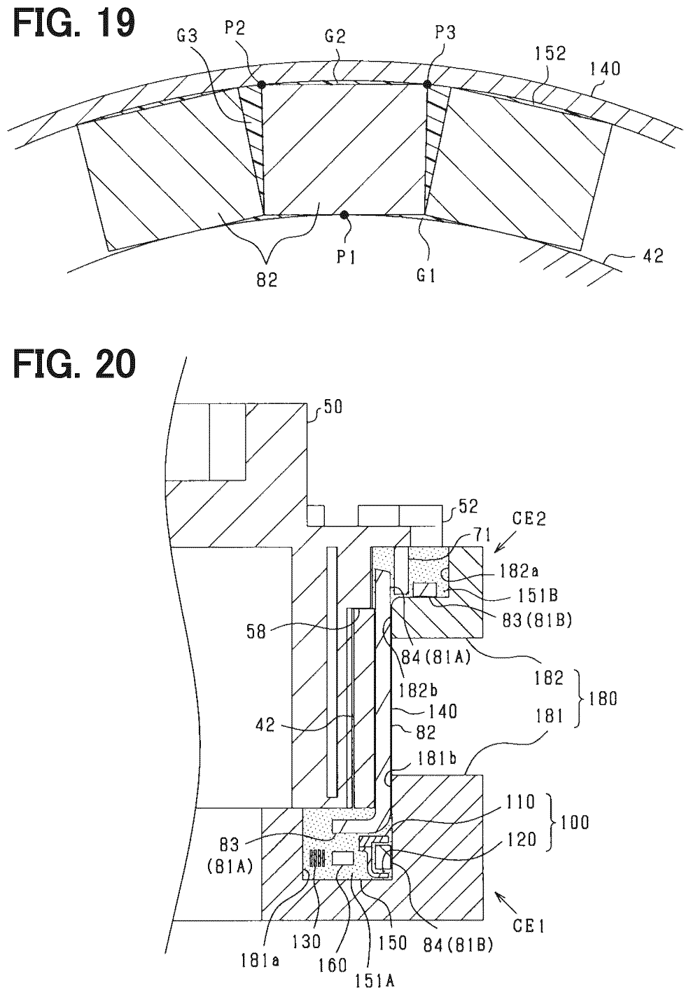

FIG. 19 is an enlarged cross-sectional view illustrating the stator core 42, the intermediate conductor portions 82 of the winding segments 81, and the coil cover 140. As illustrated in FIG. 19, the intermediate conductor portions 82 are arranged side by side in the circumferential direction on the outer peripheral face of the stator core 42, and the coil cover 140 is attached at a position radially outward of each of the intermediate conductor portions 82. In this case, a small gap is considered to be formed between these members.

Specifically, since the cross section of the intermediate conductor portion 82 has a quadrangular shape and the outer peripheral face of the stator core 42 is a curved face, the intermediate conductor portion 82 is in contact with the outer peripheral face of the stator core 42 at a midpoint P1 of the lateral face facing the core, and gaps G1 having respective wedge shapes are formed adjacent to the midpoint P1 in the circumferential direction. The coil cover 140 provided to encircle each of the plurality of intermediate conductor portions 82 is in contact with the intermediate conductor portion 82 at two corner portions P2, P3, and a gap G2 is formed between the corner portions P2, P3. A gap G3 is formed between the intermediate conductor portions 82 in the circumferential direction.

The intermediate conductor portions 82 of the winding segments 81 are conductor portions formed by gathering a plurality of conductor wires, and thus deformation of the cross section of the intermediate conductor portion 82 is considered to occur due to a press made by the coil cover 140, heat stress during use of the rotary electric machine 10, or the like.

In contrast, in the present embodiment, the coil side resin portion 152 is configured by interposing a resin in each of the gaps G1 to G3, and thus positional displacement and deformation in each of the intermediate conductor portions 82 are reduced. That is, each of the gaps G1 to G3 is filled with the resin, whereby unintentional, radial or circumferential displacement of the conductor wires forming the intermediate conductor portion 82 is reduced and thus the positional displacement and deformation of each of the intermediate conductor portions 82 are reduced.

In the configuration where the coil side resin portion 152 is interposed between the stator core 42 and the coil cover 140, more specifically, between the intermediate conductor portion 82 and the coil cover 140, a concern exists that the resin may pass beyond the coil cover 140 and leaks out toward an air gap. In this regard, in the present embodiment, the coil cover 140 is provided, without a gap, over the entire coil side portion as described above, and thus unintentional leakage of the resin toward the air gap is prevented.

In the molded resin portion 150, each of the coil end resin portions 151A, 151B in both axial end ranges and the coil side resin portion 152 are provided to be axially continuous with each other. That is, the gaps G1 to G3 in the coil side CS are open to both axial end ranges, and through the openings, each of the coil end resin portions 151A, 151B is provided to be axially continuous with the resin interposed between the core assembly CA and the coil cover 140. In this case, in FIGS. 18A and 18B, the coil end resin portions 151A, 151B in both axial end ranges are in a state of being connected through the coil side resin portion 152 (see FIG. 19).

The coil cover 140 is preferably provided in a range between the coil end resin portions 151A, 151B provided in both axial end ranges, at a position radially outward of the stator winding 41 (winding segments 81). In the present embodiment, the coil cover 140 is provided in an air gap forming range across which an air gap is formed between the stator winding 41 and the rotator 20, that is, a range corresponding to the coil side CS in the axial direction, to cover the entire range.

However, the coil cover 140 may be provided in a range obtained by extending the air gap forming range, in the axial direction, across which the air gap is formed between the stator winding 41 and the rotator 20 (a range obtained by extending the coil side CS in the axial direction), to cover the entire range.

A configuration may be made in which a resin is interposed between the stator core 42 and the stator holder 50. This configuration reduces rattling of the stator core 42 with respect to the stator holder 50. As described above, the raised portions and the recessed portions are formed on the portions facing radially inward and outward, in the stator core 42 and the stator holder 50 (see FIG. 5), and the stator core 42 and the stator holder 50 are coupled by projection-recess fitting using the raised portions and the recessed portions. In this case, a configuration is preferably made in which the resin is interposed in a gap between the two members. The assembling of the stator core 42 to the stator holder 50 may be performed by shrink fitting, pin fixing, or the like, other than the projection-recess fitting described above.

Next, a procedure of preparing the molded resin portion 150 will be described.

Here, first, the winding segments 81 are assembled to the cylindrical core assembly CA such that the intermediate conductor portions 82 of the winding segments 81 are arranged in the circumferential direction (this step corresponds to a first step).

The state in which the assembling of the winding segments 81 is completed is the state of FIG. 17 described above. The wiring module 130 is assembled to the assembly obtained after the winding segments 81 are assembled.

Thereafter, the coil cover 140 is assembled to the intermediate conductor portions 82 arranged in the circumferential direction from a position opposite to the core assembly CA to cover the entire coil side CS in the stator winding 41 (this step corresponds to a second step). In this step, the long material La formed of the prepreg is spirally wound to encircle the outer periphery of each of the intermediate conductor portions 82, and after the winding, the pieces of the impregnation material of the prepreg are bonded to each other in the axial direction, whereby the coil cover 140 is assembled to the intermediate conductor portions 82. In this case, the winding of the long material La is performed while pressing strength against the winding segments 81 is adjusted. The entire facing portion, in the stator winding 41, facing the rotator 20 is covered without a gap while strength of the coil cover 140 is retained through the core material of the long material La.

Thereafter, resin-molding is performed on the stator 40 to prepare the molded resin portion 150 (this step corresponds to a third step). Specifically, as illustrated in FIG. 20, the molded resin portion 150 is prepared by using a mold apparatus 180. In FIG. 20, the stator 40 is set on the mold apparatus 180 such that the coil end CE2 is positioned upper in the vertical direction and the coil end CE1 is positioned lower in the vertical direction, and the resin-molding is performed. However, the vertical positions thereof may be reversed.

Specifically, the mold apparatus 180 includes vertically segmented molds 181, 182. The mold 181 includes an annular groove portion 181a extending in the circumferential direction, and the stator 40 is set on the mold 181 such that the crossover portions 83, 84 in the range of the coil end CE1, the position restriction member 100, the wiring module 130, and the like are placed in the annular groove portion 181a. The mold 182 includes an annular recessed portion 182a extending in the circumferential direction, and the mold 182 is set with respect to the stator 40 such that the crossover portions 83, 84 in the range of the coil end CE2, the position restriction member 70, and the like are surrounded by a peripheral wall of the annular recessed portion 182a. The mold 182 is preferably able to be segmented into a plurality of parts in the circumferential direction.

In a state where the molds 181, 182 are set with respect to the axial one end and the axial other end of the stator 40, wall faces 181b, 182b of the molds 181, 182 face the coil cover 140. In this case, the molds 181, 182 are set in a state where the wall faces 181b, 182b do not squash the coil cover 140 in the radial direction (that is, the wall faces 181b, 182b do not squash the gap G2 in FIG. 19) and are in close contact with the coil cover 140. In this case, a face, of the coil cover 140, facing away from the conductor portions is a non-filled portion that is free of resin filling.

Then, for example, a liquid resin is injected from a resin injection port (not illustrated) provided in the mold 181. After the resin enters the annular groove portion 181a of the mold 181, the resin further enters the gap between the stator core 42 and the coil cover 140 from the annular groove portion 181a, passes through the gap, and flows into the annular recessed portion 182a of the mold 182 corresponding to the coil end CE2. At this time, the resin is injected from the lower in the vertical direction, and spaces in the molds 181, 182 and the gap between the stator core 42 and the coil cover 140 are filled with the resin while the resin is pushed upward together with air. At this time, by allowing the flow of the resin to be directed from the lower to the upper in the vertical direction, remaining of air is prevented.

In the coil side CS, a space between the stator core 42 and each of the intermediate conductor portions 82 facing each other in the radial direction (the gap G1 in FIG. 19), a space between the intermediate conductor portion 82 and the coil cover 140 facing each other in the radial direction (the gap G2 in FIG. 19), and a space between the intermediate conductor portions 82 facing each other in the circumferential direction (the gap G3 in FIG. 19) are filled with the resin. As a result, the coil side resin portion 152 is formed. At this time, since the coil cover 140 is provided over the entire coil side CS, the resin does not leak out to the face, of the coil cover 140, facing away from the conductor portions (that is, the face facing the rotator 20 out of the inner and outer faces of the coil cover 140). Thus, in the coil cover 140, the resin does not adhere to the face facing the rotator 20.

The coil end resin portion 151A is formed by the annular groove portion 181a of the mold 181, and the coil end resin portion 151B is formed by the annular recessed portion 182a of the mold 182. After the filling with the resin is completed, the resin is cured by heat treatment.

In the present embodiment, the winding segment 81 of the stator winding 41 forms a unit coil in which rectangular wires serving as the conductor wires are bundled. In such a configuration, if a gap filled with air exists between the rectangular wires, the heat dissipation performance of the stator winding 41 is considered to be reduced due to the existence of the gap filled with air. That is, if a gap filled with air exists between the rectangular wires in the coil side CS, the discharge of heat through conduction from each rectangular wire to the stator core 42 (core assembly CA) is impaired, and a concern about reduction in the heat dissipation performance due to the impairment arises.

Therefore, in the present embodiment, to improve the heat dissipation performance of the stator winding 41, a configuration is made in which an insulating layer 85 formed of an insulating material having heat dissipation performance higher than air is formed between the rectangular wires and on the exterior of a conductor-gathered portion where the rectangular wires are gathered, in the winding segment 81. Here, the configuration of each winding segment 81 will be described again.

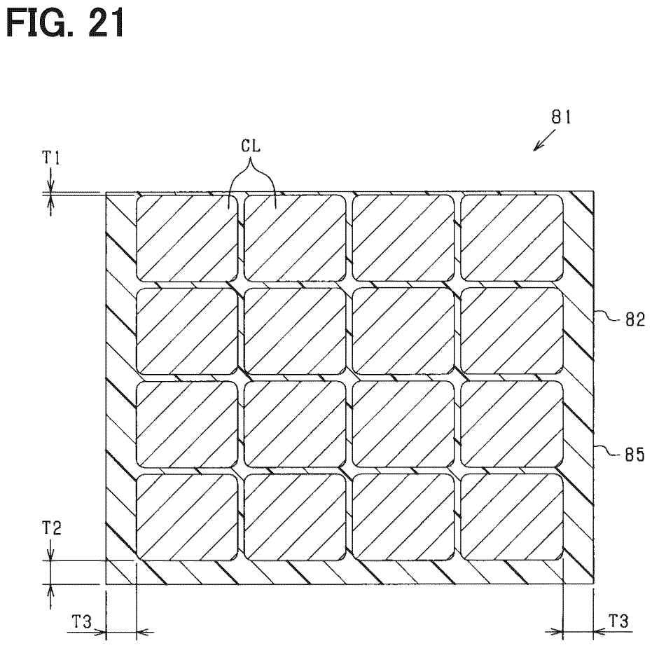

FIG. 21 is a cross-sectional view illustrating a cross section of the conductor-gathered portion in the winding segment 81. FIG. 21 illustrates a cross section of the intermediate conductor portion 82 in the winding segment 81, but the respective cross sections of the crossover portions 83, 84 are similar to the cross section of the intermediate conductor portion 82.

As illustrated in FIG. 21, the winding segment 81 is formed of a bundled wire bundling a rectangular wire CL having a rectangular cross-sectional shape, and the cross section of the winding segment 81 is formed in a quadrangular shape by aligning, in an overlapping manner, the same number of rectangular wires CL in two directions orthogonal to each other. The rectangular wire CL is preferably a conductor in which an insulating coating film is provided on a conducting body having a rectangular cross section. In the winding segment 81, the insulating layer 85 formed of the insulating material having heat dissipation performance higher than air is configured to be formed between the rectangular wires CL and on the exterior of the gathered portion of the rectangular wires CL.

In this case, in the winding segment 81, a configuration is formed in which no gap filled with air exists between the rectangular wires CL by filling the gap between the rectangular wires CL with the insulating material. Thus, the discharge of heat through conduction from each rectangular wire CL to the core assembly CA is facilitated. That is, the insulating material of the insulating layer 85 is, for example, an epoxy resin, and thermal conductivity thereof is higher than the thermal conductivity of air. The thermal conductivity of the epoxy resin is 0.3 [W/mK], and the thermal conductivity of the air is 0.025 [W/mK]. Thus, in the configuration where the gap between the rectangular wires CL is filled with the insulating material, the discharge of heat through conduction to the core assembly CA is facilitated as compared with the case where the gap filled with air exists between the rectangular wires CL.

In the conductor-gathered portion of the winding segment 81, four lateral faces, facing in four directions, that are outer faces of the conductor-gathered portion, have respective different requirements for insulation with respect to respective counterparts faced by the lateral faces. Specifically, phase-to-phase insulation is required between the winding segments 81 in the circumferential direction, and insulation to the earth is required at an edge facing the core assembly CA of both radial edges of the winding segment 81. In contrast, at an edge facing the rotator 20 (an edge opposite to the edge facing the core assembly CA) of both radial edges of the winding segment 81, the insulation as described above is unnecessary.

Therefore, in the present embodiment, a configuration is made in which the insulating layer 85 on the lateral face facing the rotator 20, among the lateral faces of the conductor-gathered portion of the winding segment 81, has a thickness thinner than the thickness of the insulating layer 85 on each of the other lateral faces. In FIG. 21, the upper in the drawing is a direction toward the rotator 20, the lower in the drawing is a direction facing away from the rotator (a direction toward the core assembly CA), and the relationship of thicknesses T1, T2 of the insulating layer 85 on the respective lateral faces in the upper and lower in the drawing is T1<T2. With this configuration, an excessive increase in the air gap can be suppressed while desired insulation to the earth can be achieved in the winding segment 81.

On the lateral faces other than the lateral face facing the rotator 20 among the lateral faces of the conductor-gathered portion of the winding segment 81, the thickness T2 of the insulating layer 85 on the lateral face facing the core assembly CA (the lateral face in the lower in FIG. 21) is configured to be thicker than a thickness T3 of the insulating layer 85 on each of the lateral faces in the circumferential direction (the lateral faces in the left and right in FIG. 21). In this case, when the thicknesses at both radial edges and at both circumferential edges are compared, the relationship of T2>T3>T1 is preferably satisfied. The thicknesses of the insulating layer 85 at both circumferential edges may be differently set.

The thicknesses of the insulating layer 85 on the lateral faces in the conductor-gathered portion of the winding segment 81 are preferably adjusted in accordance with a voltage applied to the stator winding 41 and a permittivity of the insulating material. For example, when an insulating material having a low permittivity is used, the thickness of the insulating layer 85 is preferably reduced.

Next, a procedure of manufacturing the winding segment 81 will be described.

Here, first, the winding segment 81 including an air-core unit coil formed by bundling the rectangular wire CL is prepared (a winding preparation step).

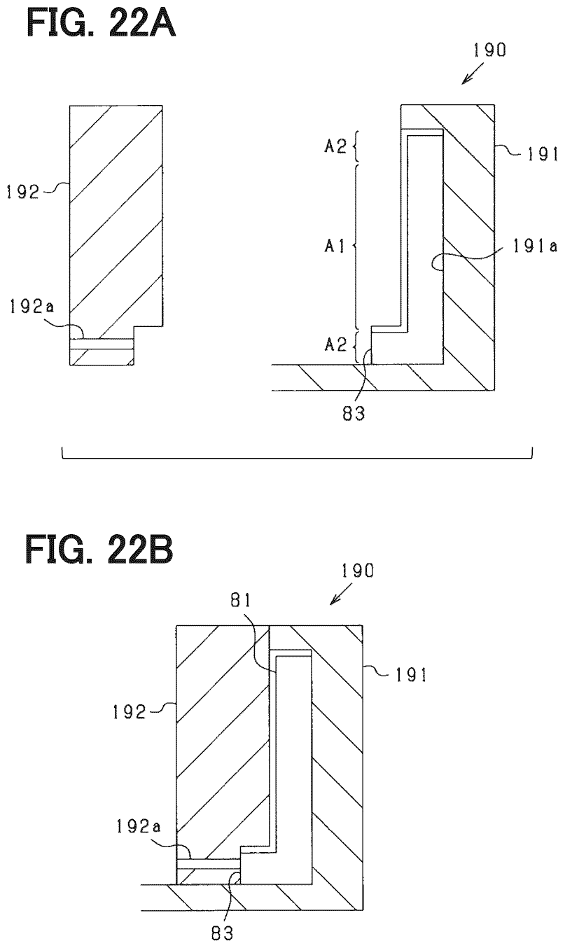

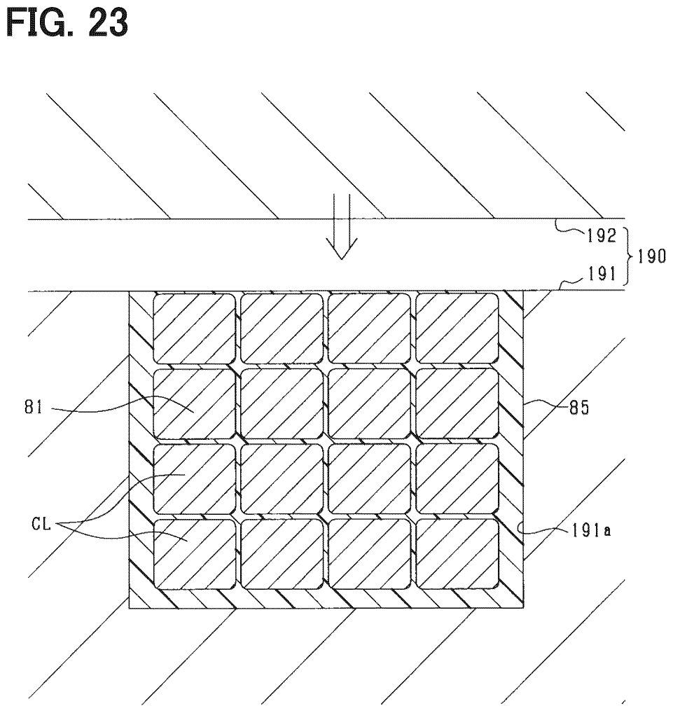

Thereafter, the insulating layer 85 is formed by filling the space between the rectangular wires CL and the space on the exterior of the conductor-gathered portion with a resin serving as an insulating material (a filling step). Specifically, as illustrated in FIGS. 22 and 23, the filling with the resin is performed by using a resin forming apparatus 190.

Specifically, the resin forming apparatus 190 includes two forming molds 191, 192 that can be segmented. The forming mold 191 includes a receiving recessed portion 191a formed in accordance with the air-core shape of the winding segment 81, and the conductor-gathered portion of the winding segment 81 is placed in the receiving recessed portion 191a. As illustrated in FIG. 23, the receiving recessed portion 191a is formed with an opening dimension larger than the cross section of the conductor-gathered portion of the winding segment 81. The winding segment 81 is set in the forming mold 191 such that the crossover portion 83 that is bent in the winding segment 81 is positioned lower in the vertical direction and the crossover portion 84 that is unbent in the winding segment 81 is positioned upper in the vertical direction.

The forming mold 192 can be assembled to the forming mold 191 from a position facing the opening of the receiving recessed portion 191a, and by assembling the forming mold 192 to the forming mold 191, a closed space inside which the entire winding segment 81 is placed is formed in the resin forming apparatus 190. The forming mold 192 is provided with a resin injection port 192a at a position facing the crossover portion 83 of the winding segment 81.

When a liquid resin is injected from the resin injection port 192a of the forming mold 192 in a state where the winding segment 81 is placed inside the resin forming apparatus 190, the resin flows into a gap between each of the forming molds 191, 192 and the winding segment 81 and a gap between the rectangular wires CL. At this time, the resin is injected from the lower in the vertical direction, and the gap portion inside the resin forming apparatus 190 is filled with the resin while the resin is pushed upward together with air. At this time, by allowing the flow of the resin to be directed from the lower to the upper in the vertical direction, remaining of air is prevented. Although not illustrated, for example, an air discharge hole is preferably provided at an upper position of the forming mold 191.

The viscosity of the resin injected into the resin forming apparatus 190 is preferably adjusted by temperature adjustment or the like to increase penetration properties into the small gap in the winding segment 81. For example, the viscosity of the resin is preferably about 100 [Pa·s] or less. By adjusting the viscosity of the resin, the penetration properties or the filling rate can be improved.

Here, in the winding segment 81, assuming that a portion corresponding to the coil side CS is a first portion A1 and a portion corresponding to each of the coil ends CE1, CE2 is a second portion A2, the first portion A1 is placed inside the resin forming apparatus 190 while the first portion A1 is directed to extend in the vertical direction. Thus, in the first portion A1, the gap between the rectangular wires CL extends in the vertical direction. Then, by injecting the resin from the second portion A2 on the lower in the vertical direction out of the second portions A2 adjacent to the first portion A1, and along with the rise of the liquid level due to the injection of the resin, the air inside the resin forming apparatus 190 is gradually pushed upward. As a result, the gap between the rectangular wires CL is filled with the resin while air bubbles are removed.

The first portion A1 (coil side corresponding portion) is a portion from which remaining air bubbles between the rectangular wires CL are desired to be removed as compared with the second portion A2 (coil end corresponding portion), and according to the above manufacturing method, the removal of the air bubbles can be achieved in the first portion A1 as desired.

After the filling with the resin, a curing treatment on the resin is performed. As described above, in the filling step, the insulating layer 85 formed of a resin (insulating material) is formed between the rectangular wires CL and on the exterior of the conductor-gathered portion in which the rectangular wires CL are gathered.

According to the above method of forming the insulating layer 85, the insulating layer 85 having a small thickness can be formed between the rectangular wires CL or on the exterior of the conductor-gathered portion. That is, for example, in a configuration where a bobbin or an insulating sheet formed of a resin is attached to the exterior of a conducting-body-gathered portion, the thickness thereof is 0.3 mm or more in accordance with the strength requirement or the like. In contrast, according to the above method, the thickness of the insulating layer 85 can be set to about 0.1 mm. As a result, a space factor in the stator winding 41 can be improved.

After the winding segment 81 is prepared as described above, the winding segment 81 is assembled to the core assembly CA (an assembling step). The state in which the assembling is completed is the state of FIG. 17 described above.

In the present embodiment, the configuration is made in which the gap filled with air between the rectangular wires CL is eliminated by filling the gap between the rectangular wires CL with the insulating layer 85, in the winding segment 81, as described above. However, the air bubbles are considered to remain without being completely removed at the time of the filling with the resin on the winding segment 81. Specifically, in the winding segment 81, the extending direction of the rectangular wire CL is different between the intermediate conductor portion 82 and each of the crossover portions 83, 84, and air bubbles are easily removed for the intermediate conductor portion 82 while air bubbles easily remain for the crossover portions 83, 84, at the time of the resin filling. Therefore, on the first portion A1 (coil side corresponding portion), the insulating layer 85 is considered to contain air bubbles fewer than the air bubbles contained in the insulating layer 85 on the second portion A2 (coil end corresponding portion).

In this regard, when viewed at the level of the stator 40, in the coil side CS of the winding segment 81, the insulating layer 85 contains relatively fewer air bubbles, and thus heat is suitably discharged through conduction from the intermediate conductor portion 82 to the core assembly CA. In contrast, in the coil ends CE1, CE2 of the winding segment 81, the insulating layer 85 contains relatively many air bubbles, and thus heat can be suitably discharged through radiation from the crossover portions 83, 84 to the outside. In the coil ends CE1, CE2, expansion and contraction of the insulating material due to cooling and heating are considered to be larger than those in the coil side CS, but since the number of air bubbles in the insulating material is relatively larger, the stress on the insulating material due to cooling and heating is relaxed.

As illustrated in FIGS. 22A and 22B, the winding segment 81 is set in the resin forming apparatus 190 such that the crossover portion 83 that is bent in the winding segment 81 is positioned lower in the vertical direction and the crossover portion 84 that is unbent in the winding segment 81 is positioned upper in the vertical direction. In this case, the amount of air bubbles contained in the insulating layer 85 between the rectangular wires CL is considered to be different between the axial one end range and the axial other end range of the winding segment 81 due to the difference in the forms of the crossover portions 83, 84 or the like. For example, in the crossover portions 83 that are bent, the number of conductor-gathered portions directed to extend in the non-vertical direction (horizontal direction) is larger, and the amount of air bubbles is considered to be larger than the amount of air bubbles in the crossover portions 84 that are unbent.

In this regard, in the stator 40, as illustrated in FIG. 17 and the like, the winding segments 81A, 81B are assembled such that the bent crossover portions 83 and the unbent crossover portions 84 are evenly distributed in the circumferential direction. That is, the winding segments 81A and the winding segments 81B are evenly distributed in the circumferential direction. With this configuration, variations in heat dissipation at various locations in the stator 40 are reduced. In the winding segment 81, when an end portion in which the amount of air bubbles is larger is referred to as a first end portion and an end portion in which the amount of air bubbles is smaller is referred to as a second end portion, one of the crossover portions 83, 84 is the first end portion, and the other one of the crossover portions 83, 84 is the second end portion.

After the winding segments 81 are assembled to the core assembly CA, the coil cover 140 is assembled and the molded resin portion 150 is prepared as described above. The coil end resin portion 151 and the coil side resin portion 152 are formed through the preparation of the molded resin portion 150 (see FIGS. 19 and 20).

According to the present embodiment described in detail above, the following excellent effects can be obtained.

In the rotary electric machine 10 including the stator 40 having a toothless structure, a structure for fixing the stator winding 41 is required. In this regard, the conductor portions (intermediate conductor portions 82 of the winding segments 81) assembled to the core assembly CA are configured to be covered with the coil cover 140 from a position opposite to the core assembly CA. With this configuration, the stator winding 41 can be fixed to the core assembly CA. In particular, in the configuration where the resin is interposed between the core assembly CA and the coil cover 140, the coil cover 140 is configured to be provided to cover the entire coil side portion of the stator winding 41. In this case, inconvenience that the resin interposed between the core assembly CA and the coil cover 140 passes beyond the coil cover 140 in the radial direction and unintentionally leaks out to the face facing the rotator 20 is reduced. As a result, the stator winding 41 can be held in an appropriate state.

Since the coil cover 140 is formed of a non-magnetic body, the influence of the coil cover 140 on magnetic flux, between the stator winding 41 and the rotator 20 can be reduced, and thus the influence on the performance of the rotary electric machine 10 can be reduced.

The coil cover 140 is configured by winding the long material La to encircle the outer peripheries of the conductor portions arranged in the circumferential direction. With this configuration, a pressing force applied from the coil cover 140 for holding the conductor portions can be easily and freely adjusted. In this case, in a state where the long material La is wound, the stator winding 41 is held in a state of being pressed toward the core assembly CA. Thus, the stator winding 41 is pressed against the core assembly CA, and heat dissipation performance from the stator winding 41 to the core assembly CA can be enhanced.

When the conductor portions of the stator winding 41 (the intermediate conductor portions 82 of the winding segments 81) are conductor portions formed of gathered conductor wires (the rectangular wires CL), and when each of the conductor portions has a quadrangular cross section, a gap is likely to be formed between the core assembly CA and the conductor portion in a state where the conductor portion is assembled to the cylindrical core assembly CA, and a concern arises that the positional displacement or the deformation of the conductor portions arranged in the circumferential direction may occur due to the formation of the gap. In this regard, the resin is interposed between the core assembly CA and the conductor portion facing each other in the radial direction, whereby the gap is filled with the resin, between the core assembly CA and the conductor portion, and the positional displacement and the deformation of each conductor portion can be reduced.

The resin is interposed between the coil cover 140 and the conductor portion facing each other in the radial direction, whereby the gap between the coil cover 140 and the conductor portion is filled with the resin, and the positional displacement and the deformation of each conductor portion can be reduced. The coil cover 140 is provided to cover the entire facing portion, in the stator winding 41, facing the rotator 20 as described above, whereby the passage of the resin across the inner face and the outer face of the coil cover 140 in the radial direction can be suitably prevented, while the positional displacement of each conductor portion can be reduced by the resin between the coil cover 140 and the conductor portion.

The configuration is made in which the position of the stator winding 41 is restricted by the position restriction members 70, 100 in the coil ends CE1, CE2, and thus holding strength needed for the coil cover 140 to hold the conductor portions is sufficient as long as the coil cover 140 can hold the conductor portions at least in the radial direction. That is, the configuration is made in which the roles of the position restriction on the stator winding 41 in the radial direction and the other directions can be respectively allotted to the coil cover 140 and the position restriction members 70, 100. Thus, the requirement for strength in the coil cover 140 can be lowered, and the configuration can be simplified.

The coil end resin portion 151 covering each of the coil ends CE1, CE2 of the stator 40 is configured to be provided to be axially continuous with the resin interposed between the core assembly CA and the coil cover 140, and thus an advantageous configuration can be achieved from the viewpoint of heat dissipation performance and the viewpoint of manufacturing.

As a procedure of preparing the molded resin portion 150 on the stator 40, the winding segments 81 are assembled to the core assembly CA (the first step), then the coil cover 140 is assembled to the intermediate conductor portions 82 of the winding segments 81 to cover the entire coil side portion of the stator winding 41 (the second step), and in this state, the gap between the core assembly CA and the coil cover 140 is filled with a resin (the third step). In this preparation procedure, inconvenience that the resin passes beyond the coil cover 140 in the radial direction and unintentionally leaks out to the outside (the face facing the rotator 20) is reduced. As a result, the stator winding 41 can be held in an appropriate state.

In the winding segment 81 including the air-core unit coil formed by bundling the rectangular wire CL, the configuration is made in which the insulating layer 85 formed of an insulating material having heat dissipation performance higher than air is formed between the rectangular wires CL and on the exterior of the conductor-gathered portion where the rectangular wires CL are gathered. With this configuration, the gap between the rectangular wires CL can be filled with the insulating material, and the discharge of heat through conduction from each rectangular wire CL to the core assembly CA can be facilitated. As a result, the heat dissipation performance can be improved in the stator 40.

In the stator 40 having a toothless structure, phase-to-phase insulation between the winding segments 81 is required in the circumferential direction, and insulation to the earth is required at the edge facing the core assembly CA of both radial edges of the winding segment 81. At the edge facing the rotator 20 of both radial edges of the winding segment 81, the insulation as described above is unnecessary. In consideration of this point, the insulating layer 85 is configured such that the insulating layer 85 on the lateral face facing the rotator 20, among the four lateral faces, facing in four directions, of the conductor-gathered portion of the winding segment 81 has a thickness thinner than the thickness of the insulating layer 85 on each of the lateral faces other than the lateral face facing the rotator 20. With this configuration, an excessive increase in the air gap can be suppressed while desired insulation can be achieved in the winding segment 81.

In the coil ends CE1, CE2, the configuration is made in which the positions of the winding segments 81 in a state of being assembled to the core assembly CA are restricted by the position restriction members 70, 100, and thus relative vibration generated in the winding segments 81 is reduced. In this case, in combination with the configuration where the space between the rectangular wires CL is filled with the insulating material, a decrease in the insulation property due to vibration-based wear in the rectangular wires CL can be reduced.

In the winding segment 81, the configuration is made in which the air bubbles contained in the insulating layer 85 are fewer in the first portion A1 that is the coil side corresponding portion than in the second portion A2 that is the coil end corresponding portion. In this case, in the first portion A1 (coil side corresponding portion) of the winding segment 81, heat can be suitably discharged through conduction from the first portion A1 to the core assembly CA because the number of air bubbles in the insulating layer 85 is relatively smaller, while in the second portion A2 (coil end corresponding portion) of the winding segment 81, heat can be suitably discharged through radiation from the second portion A2 to the outside because the number of air bubbles in the insulating layer 85 is relatively larger.

In each of the coil ends CE1, CE2, expansion and contraction of the insulating material due to cooling and heating are considered to be larger than those in the coil side CS. However, by causing the number of air bubbles in the insulating layer 85 to be relatively larger in the second portion A2, relaxation of the stress on the insulating layer 85 due to cooling and heating can be achieved.

In the winding segment 81, the distribution of the air bubbles existing in the insulating layer 85 is considered to be different in the longitudinal direction of the winding segment 81, that is, in the axial one end range and the axial other end range. Focusing on this point, the configuration is made in which the winding segments 81 are assembled to the core assembly CA in a state where in the axial one end range and the axial other end range of the stator 40, the first end portion where the amount of air bubbles is larger and the second end portion where the amount of air bubbles is smaller are evenly distributed in the circumferential direction. With this configuration, variations in heat dissipation at various locations in the stator 40 can be reduced.

As a procedure of forming the insulating layer 85 in the winding segment 81, the air-core winding segment 81 formed by bundling the plurality of rectangular wires CL is prepared (the winding preparation step), then, the resin forming apparatus 190 inside which the winding segment 81 is placed is filled with a liquid insulating material having heat dissipation performance higher than air to form the insulating layer 85 formed of the insulating material between the rectangular wires CL and on the exterior of the conductor-gathered portion (the filling step), and the winding segment 81 having been subjected to the filling is assembled to the core assembly CA (the assembling step). According to this procedure, in the winding segment 81, the insulating layer 85 is suitably formed by filling the space between the rectangular wires CL and the space on the exterior of the conductor-gathered portion with the insulating material having heat dissipation performance higher than air. In this case, the stator winding 41 having excellent heat dissipation performance and an excellent insulation property can be prepared.

In the filling step of filling with the insulating material, the winding segment 81 is placed inside the resin forming apparatus 190 while the first portion A1, which is the coil side corresponding portion, is directed to extend in the vertical direction, and in the resin forming apparatus 190, the insulating material is injected from the second portion A2 on the lower in the vertical direction out of the second portions A2 adjacent to the first portion A1. In this case, in the first portion A1, the gap between the rectangular wires CL extends in the vertical direction, and along with the rise of the liquid level due to the injection of the insulating material, the air inside the resin forming apparatus 190 is gradually pushed upward. As a result, in the gap between the rectangular wires CL, the insulating layer 85 can be suitably formed while air bubbles are removed.

### Modifications of First Embodiment

In the filling step of forming the insulating layer 85 by filling the space between the rectangular wires CL and the space on the exterior of the conductor-gathered portion with a resin, resin filling can also be performed in a mode different from the mode of the resin-molding performed by the resin forming apparatus 190 as illustrated in FIGS. 22A and 22B. For example, in the resin forming apparatus 190, the winding segment 81 may be set such that the unbent crossover portion 84 is positioned lower in the vertical direction and the bent crossover portion 83 is positioned upper in the vertical direction. In the resin forming apparatus 190, the winding segment 81 may be set such that the intermediate conductor portion 82 is directed to extend in the horizontal direction and the intermediate section of each of the crossover portions 83, 84 is directed to extend in the vertical direction or the horizontal direction.

The coil cover 140 may be formed by using a magnetic material. However, considering insulation from the stator winding 41, the coil cover 140 may be nonmetallic and nonmagnetic.

In the winding segment 81, the insulating layer between the rectangular wires CL and the insulating layer on the exterior of the conductor-gathered portion may be formed of respective different insulating materials (resins). For example, since for the gap between the rectangular wires CL, the resin filling is performed on the gap narrower than the gap on the exterior of the conductor-gathered portion, the resin between the rectangular wires CL is preferably lower in viscosity than the resin on the exterior of the conductor-gathered portion.

The surface of the rectangular wire CL is preferably subjected to a surface treatment with which water repellency of the surface is enhanced. In this configuration, a water-repellent layer is formed on the surface of the rectangular wire CL, and thus air bubbles are less likely to adhere to the surface. Therefore, at the time of resin filling, air bubbles are easily removed in the insulating material between the rectangular wires CL, and a configuration can be achieved in which air bubbles in the insulating layer 85 are reduced.

To prevent a resin from adhering to a face, of the coil cover 140, facing the rotator 20 when the facing portion, in the stator winding 41, facing the magnet unit 22 of the rotator 20 is covered with the coil cover 140, a treatment such as a masking is performed on the entire range, of the face of the coil cover 140, that is a range to which the resin is not allowed to adhere, at the time of manufacturing the stator unit 30. In this case, to prevent leakage of the resin to the face of the coil cover 140, a seal structure is considered to be added to the manufacturing mold. However, in the configuration where the bent portion bent toward the rotator 20 is provided at the axial end portion of the stator winding 41, restriction occurs in the seal structure provided to the manufacturing mold, at or near the end portion. That is, in the manufacturing mold, to avoid interference with the bent portion of the stator winding 41, a sealing position in the manufacturing mold needs to be separated from the position of the bent portion of the stator winding 41 to some extent, and if the sealing is performed at a midway portion of the coil cover 140, a concern arises that in the coil cover 140, the resin adheres to a part of the face facing the rotator 20.

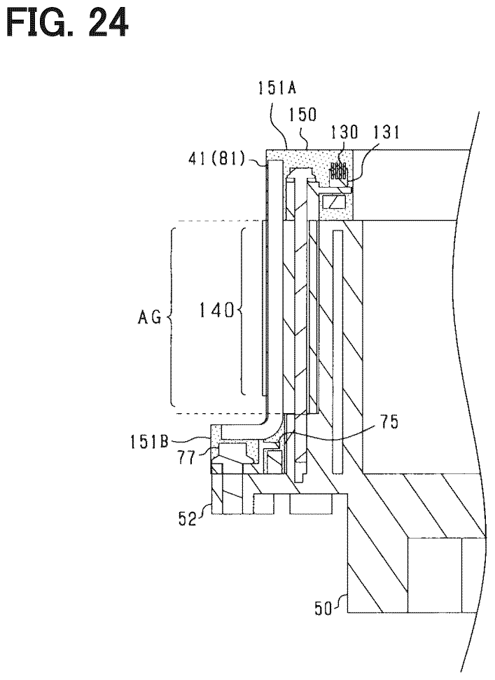

In consideration of this, the stator unit 30 preferably has a configuration illustrated in FIG. 24. In FIG. 24, in the stator winding 41, a lower end portion is the first end portion including a bent portion bent toward the rotator 20 in a radially inward or outward direction, and an upper end portion is the second end portion. A range across which the stator winding 41 faces the rotator 20 in the axial direction is an air gap forming range AG.

In FIG. 24, in the upper end range (range around the second end portion) in the drawing, the coil cover 140 is provided in a range up to at least one boundary position of the air gap forming range AG, while in the lower end range (range around the first end portion) in the drawing, the coil cover 140 is provided in a range up to a position before the other boundary position of the air gap forming range AG.

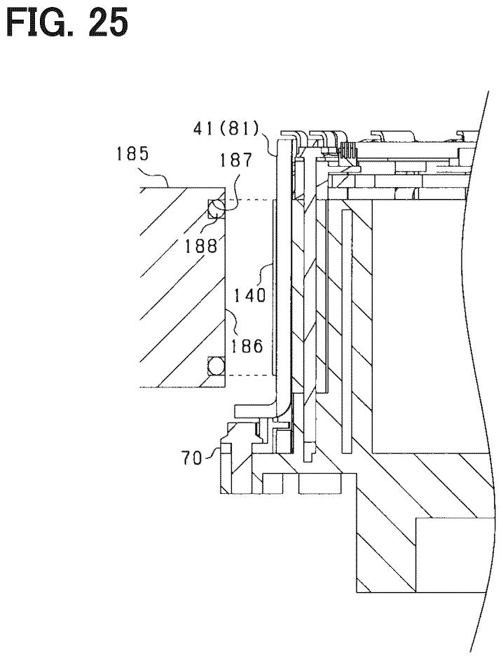

FIG. 25 is a view for explaining a mold apparatus used when resin-molding is performed on the stator 40. In FIG. 25, in the mold apparatus, only a mask apparatus 185 that masks the coil cover 140 is illustrated, and the illustration of vertically segmented molds for forming the coil end resin portions 151A, 151B is omitted. The mask apparatus 185 preferably has a circular annular shape as a whole, and is preferably able to be segmented into a plurality of parts in the circumferential direction.

The mask apparatus 185 includes a facing face 186 facing the intermediate conductor portions 82 of the winding segments 81 in the stator winding 41. The facing face 186 is provided with recessed portions 187 at two positions corresponding to the upper end position and the lower end position of the coil cover 140, and seal members 188 are placed in the recessed portions 187. In this case, at the time of resin-molding, the mask apparatus 185 is pressed against the coil cover 140, whereby masking with respect to a resin is performed in a range including the upper and lower seal members 188, which prevents the resin from adhering to the face, of the coil cover 140, facing the rotator 20.

Here, to allow the mask apparatus 185 to be provide with a seal structure having an appropriate strength at the axial end portions thereof (the upper end portion and the lower end portion in the drawing), the mask apparatus 185 needs to have a configuration that ensures thickness for ensuring the strength at respective portions extending outwardly of the recessed portions 187. That is, in the mask apparatus 185, to avoid interference with the bent portion of the stator winding 41, a sealing position in the mask apparatus 185 needs to be separated from the position of the bent portion of the stator winding 41 to some extent. Thus, in the present embodiment, the covering range of the coil cover 140 is determined in accordance with the sealing positions of the mask apparatus 185. That is, in the range around the unbent end (range around the second end portion) of the stator winding 41, the coil cover 140 is provided in the range up to at least the one boundary position of the air gap forming range AG, while in the range around the bent end (range around the first end portion), the coil cover 140 is provided in the range up to the position before the other boundary position of the air gap forming range AG.

In this case, if the sealing is performed at an axial midway portion in the coil cover 140, a concern arises that the resin adheres to a part of the face, of the coil cover 140, facing the rotator 20. However, the above configuration prevents the resin from adhering to the face of the coil cover 140. As a result, even in the configuration where the bent portion bent toward the rotator 20 is provided at the axial end portion of the stator winding 41, the masking for preventing the resin from adhering to the face, of the coil cover 140, facing the rotator 20 is suitably performed in the range around the axial end portion.

Hereinafter, configurations, and operations and effects of other embodiments will be described while focusing on differences from the first embodiment.

### Second Embodiment

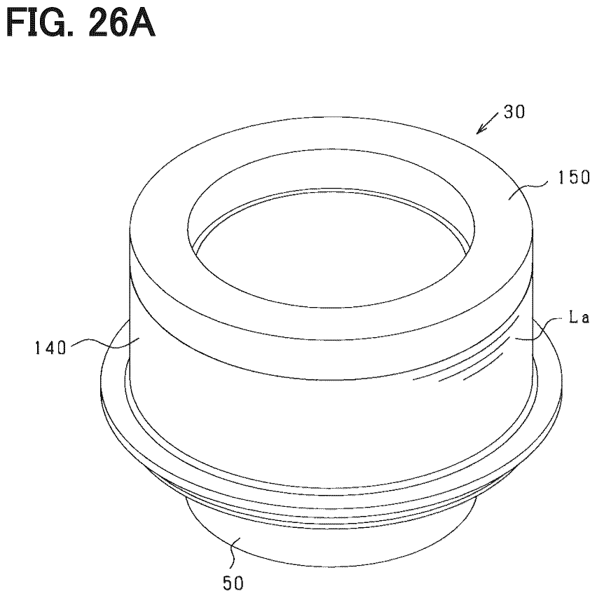

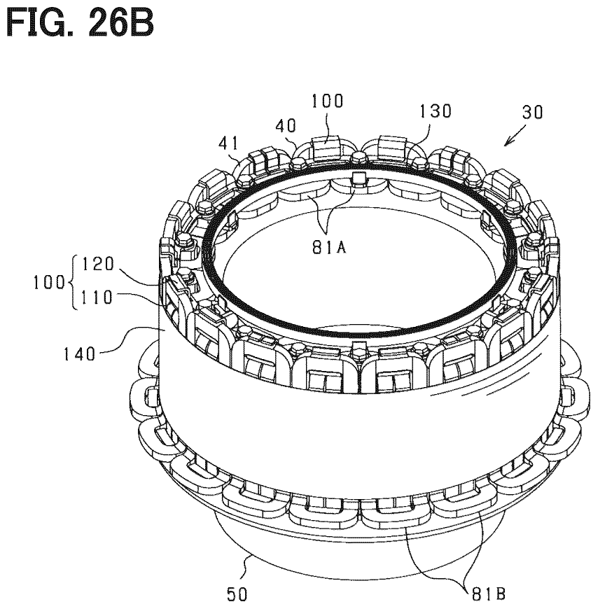

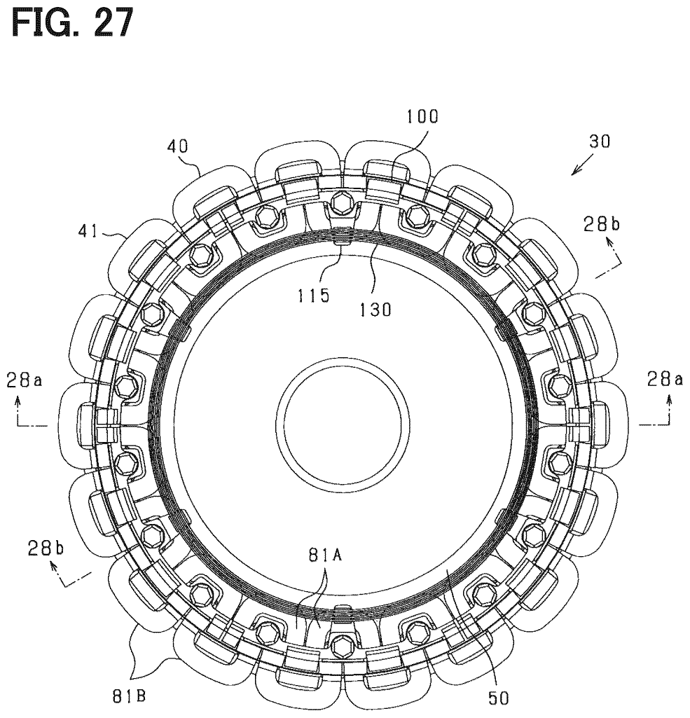

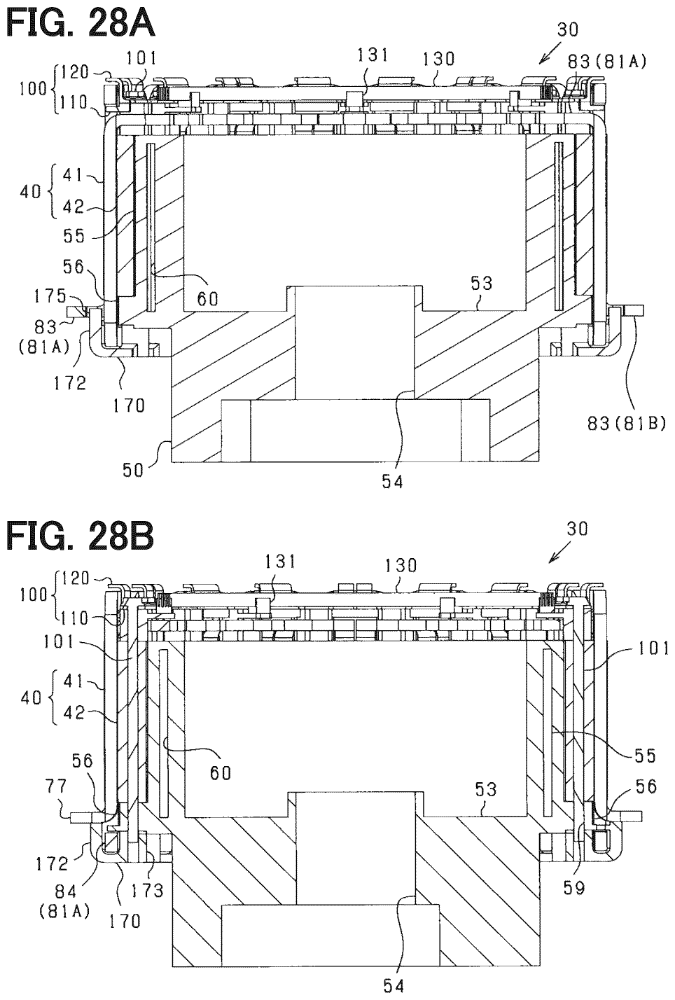

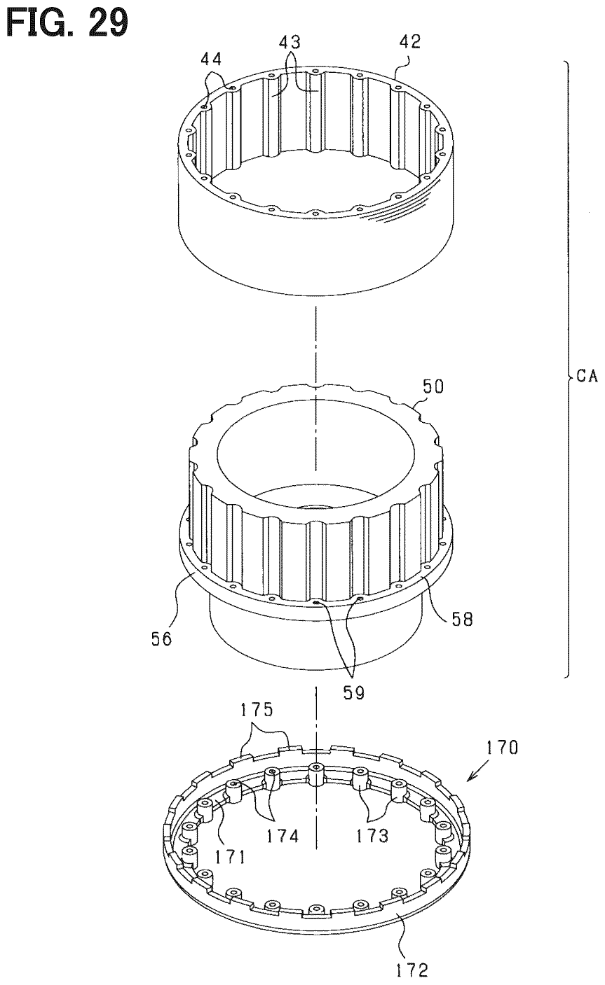

A stator unit 30 according to the present embodiment will be described. The stator unit 30 according to the present embodiment has a difference from that of the first embodiment in that a configuration is changed as to the winding position restriction in the range of the coil end CE2 of the stator unit 30. FIGS. 26A and 26B are perspective views illustrating appearances of the stator unit 30, and FIG. 26B illustrates a state in which a molded resin provided to the stator unit 30 is removed. FIG. 27 is a plan view of the stator unit 30. FIG. 28A is a cross-sectional view taken along line 28a-28a in FIG. 27, and FIG. 28B is a cross-sectional view taken along line 28b-28b in FIG. 27. FIG. 29 is a perspective view illustrating a core assembly CA according to the present embodiment and a position restriction member 170 attached to the core assembly CA in the range of the coil end CE2, in an exploded state.

In the present embodiment, the configuration in the range of the coil end CE2 is changed among the configurations as to the winding position restriction in the coil ends CE1, CE2. With this change, the outwardly-extending portion 52 is removed in the stator holder 50 of the core assembly CA. The holes 59 provided in the large-diameter portion 56 of the stator holder 50 are changed to through-holes extending therethrough in the axial direction. However, other configurations related to the core assembly CA are common to those illustrated in FIG. 5 and the like. The configuration of the position restriction member 100 in the range of the coil end CE1 is not changed, and thus the description thereof is omitted.

As illustrated in FIG. 29, the position restriction member 170 is formed in a circular annular shape, and includes an end plate portion 171 axially outward of an axial end face (lower end face in the drawing) of the large-diameter portion 56 of the stator holder 50, and an annular wall portion 172 having a circular annular shape and extending in the axial direction from an outer edge portion of the end plate portion 171. The end plate portion 171 is provided with a plurality of boss portions 173 at predetermined intervals in the circumferential direction. In the boss portions 173, respective through-holes 174 extending therethrough in the axial direction are formed.

The annular wall portion 172 is formed to have a diameter larger than the diameter of the large-diameter portion 56. A plurality of restriction portions 175 extending in the axial direction is provided on the annular wall portion 172. The restriction portions 175 are projecting portions extending in the circumferential direction, and are provided at predetermined intervals in the circumferential direction. The position restriction member 170 is formed of, for example, aluminum, an aluminum alloy, cast iron, or the like.

As illustrated in each of in FIGS. 28A and 28B, in the range of the coil end CE2, the position restriction member 170 is assembled to the stator holder 50 in a state where the boss portions 173 are in contact with the axial end face (lower end face in the drawings) of the large-diameter portion 56 of the stator holder 50. In this state, the annular wall portion 172 of the position restriction member 170 and the large-diameter portion 56 of the stator holder 50 face each other in the radial direction to form an annular groove therebetween, and the crossover portions 84 (unbent crossover portions) of the winding segments 81A are inserted into the annular groove. As a result, the radial and axial positions of the winding segments 81A are restricted in the range of the coil end CE2. Each of the restriction portions 175 of the position restriction member 170 is placed at a position annularly inward with respect to a corresponding one of the crossover portions 83 (bent crossover portions) of the winding segments 81B, whereby the circumferential positions of the winding segments 81B are restricted in the range of the coil end CE2.

A plurality of restriction portions may be provided on the annular wall portion 172, at predetermined intervals in the circumferential direction to extend radially inward. In this case, each of the restriction portions is placed at a position annularly inward with respect to a corresponding one of the crossover portions 84 of the winding segments 81A, whereby the circumferential and axial positions of the winding segments 81A are restricted in the range of the coil end CE2.

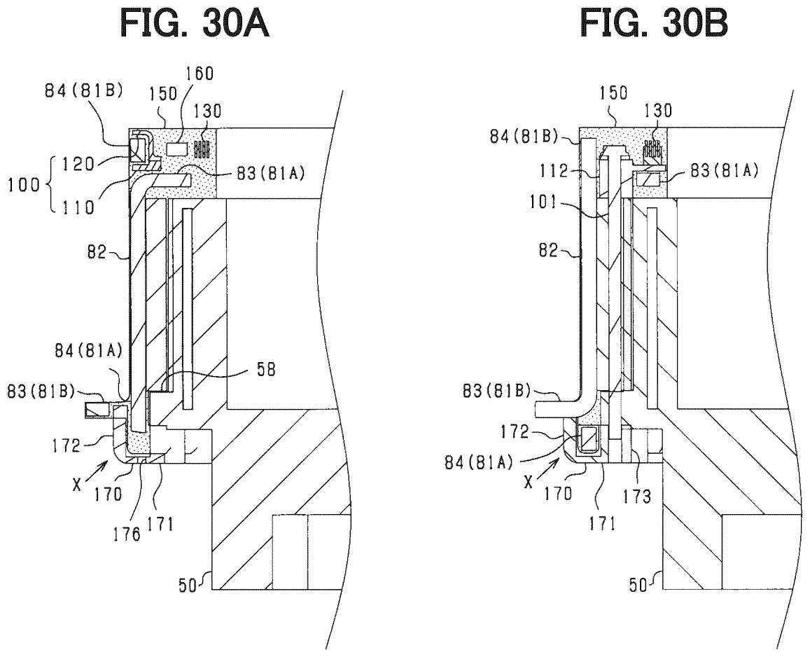

FIGS. 30A and 30B are cross-sectional views each illustrating the stator unit 30 in a state where the molded resin portion 150 is added to the stator unit 30. Note that FIG. 30A corresponds to FIG. 28A, and FIG. 30B corresponds to FIG. 28B. As illustrated in each of FIGS. 30A and 30B, the molded resin portion 150 is provided to cover a range from the position restriction member 170 in the axial one end range to the position restriction member 100 in the axial other end range, inclusive, and to cover components including the intermediate conductor portions 82 of the winding segments 81A, 81B, in the axial direction. The configuration is substantially the same as the configuration in each of FIGS. 18A and 18B described above. That is, in the coil ends CE1, CE2, a configuration is made in which a resin material enters between each of the crossover portions 83, 84 of the winding segments 81A, 81B and each of the position restriction members 170, 100 to form an insulating layer. A configuration is made in which a resin material (insulating material) is interposed between the stator core 42 and the stator holder 50.

In the range of the coil end CE2, in the position restriction member 170, a portion opposite to the stator holder 50 across the crossover portions 84 of the winding segments 81A and surrounding the crossover portions 84 from radially outside is a molding-free portion free from resin-molding (X portion in FIGS. 30A and 30B). In this case, the portion of the position restriction member 170 is an exposed portion exposed to the outside without being subjected to resin-molding, and heat dissipation performance is improved. That is, in the rotary electric machine 10, for example, oil cooling of the stator 40 can be considered that is performed by dropping lubricating oil into the inside of the rotator carrier 21. In the configuration having such an oil cooling structure, the molding-free portion (exposed portion) of the position restriction member 170 is a heat dissipation portion through which heat is dissipated by oil cooling.

As illustrated in FIG. 30A, in the end plate portion 171 axially outward of the axial end face of the stator holder 50, in the position restriction member 170, holes 176 extending therethrough in the axial direction may be provided. The holes 176 are preferably provided at positions not interfering with the boss portions 173. In this case, the annular groove portion surrounding the large-diameter portion 56 of the stator holder 50 can be filled with a resin material from the holes 176. Thus, an insulating layer can be appropriately formed in the circumferential vicinity of the position restriction member 170.

### Third Embodiment

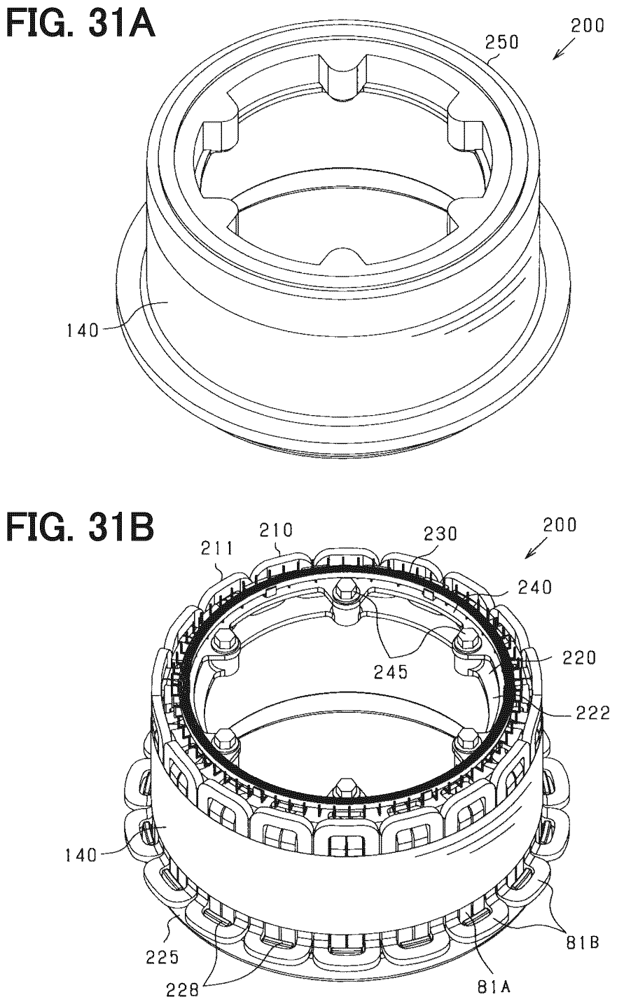

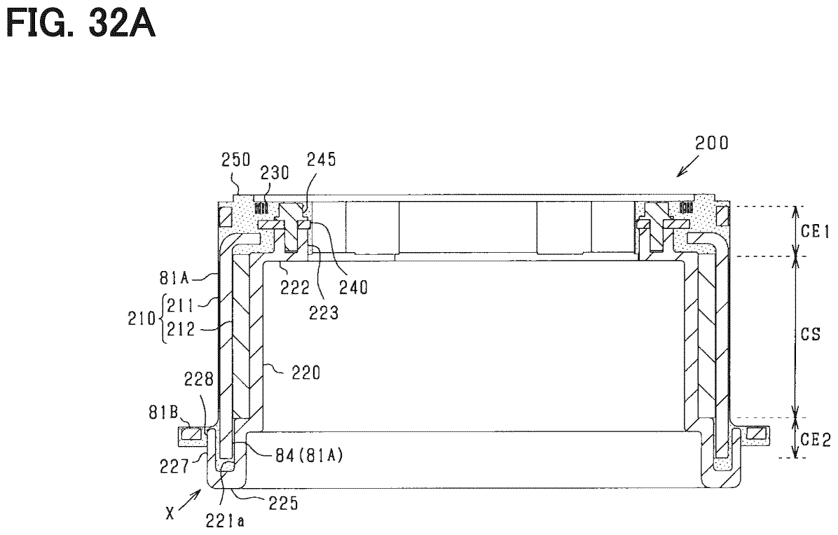

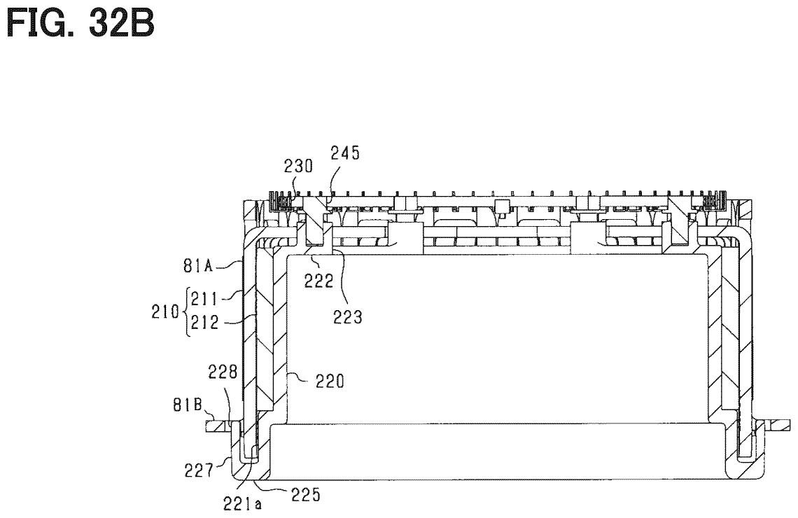

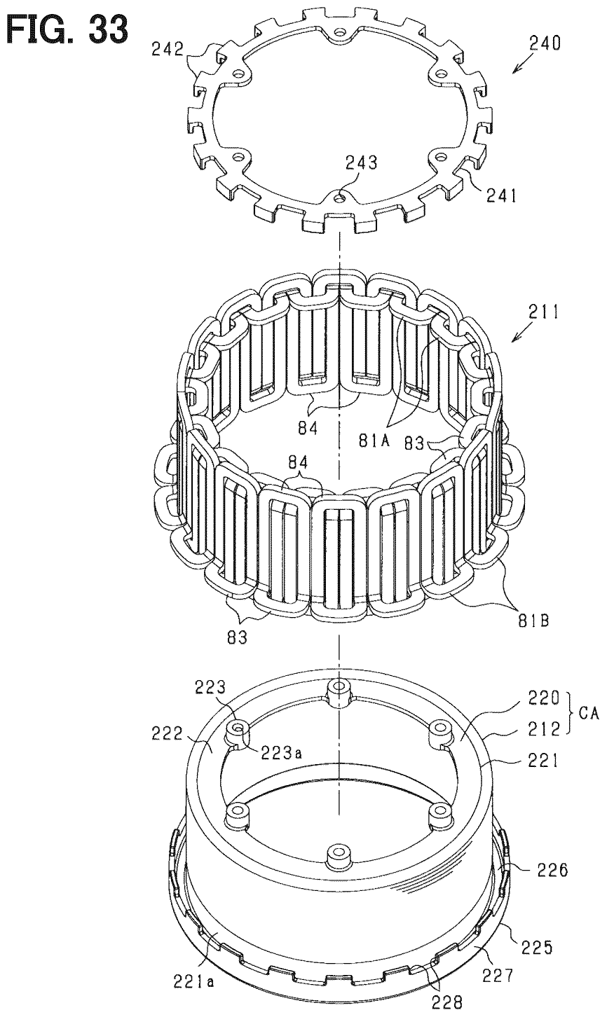

A stator unit 200 according to the present embodiment will be described. FIGS. 31A and 31B are perspective views illustrating appearances of the stator unit 200, and FIG. 31A illustrates the stator unit 200 in a state of being subjected to resin-molding and FIG. 31B illustrates the stator unit 200 in a state of being not subjected to resin-molding. FIG. 32A is a longitudinal cross-sectional view of the stator unit 200 in a state of being subjected to resin-molding, and FIG. 32B is a longitudinal cross-sectional view of the stator unit 200 in a state of being not subjected to resin-molding. FIG. 33 is a perspective view illustrating main configurations in an exploded state, in the stator unit 200.

The stator unit 200 mainly includes a stator 210, a stator holder 220 provided radially inward of the stator 210, and a wiring module 230. The stator 210 has a toothless structure, and includes a stator winding 211 and a stator core 212. A configuration is made by integrating the stator core 212 and the stator holder 220 to provide these components as a core assembly CA (see FIG. 33), and by assembling the stator winding 211 to the core assembly CA.

The stator 210 has a configuration substantially similar to that of the stator 40 described above, and the stator winding 211 includes the plurality of winding segments 81A, 81B as described above. The stator core 212 has a configuration substantially similar to that of the stator core 42 except that the stator core 212 does not include a plurality of raised portions on an inner peripheral face thereof. Detailed description of the configurations of the stator 210 similar to those of the stator 40 will be omitted. As illustrated in FIGS. 32A and 32B, a range (upper in the drawing), of both axial end ranges, in which the crossover portions 83 of the winding segments 81A are bent radially inward, is a coil end CE1, and a range (lower in the drawing), of both axial end ranges, in which the crossover portions 83 of the winding segments 81B are bent radially outward, is a coil end CE2. The wiring module 230 has the same configuration as that of the wiring module 130, and thus the description thereof will be omitted.

As illustrated in FIG. 33, the stator holder 220 includes a cylindrical portion 221, and the stator core 212 is assembled to the cylindrical portion 221. A flange portion 222 extending radially inward is formed at an axial end portion in the cylindrical portion 221 in the range of the coil end CE1. The flange portion 222 is provided with a plurality of boss portions 223 at predetermined intervals in the circumferential direction. The boss portions 223 are provided with respective holes 223a extending therethrough in the axial direction. In the holes 223a, respective internal threads are formed.

An outwardly-extending portion 225 extending radially outward with respect to the cylindrical portion 221 is provided at an axial end portion in the cylindrical portion 221 in the range of the coil end CE2. The outwardly-extending portion 225 includes an end plate portion 226 extending radially outward from the cylindrical portion 221 (large-diameter portion 221a) of the stator holder 220, and an annular wall portion 227 having a circular annular shape and extending axially from an outer edge portion of the end plate portion 226. The annular wall portion 227 is formed to have a diameter larger than the diameter of the large-diameter portion 221a. The annular wall portion 227 is provided with a plurality of restriction portions 228 extending in the axial direction. The restriction portions 228 are projecting portions extending in the circumferential direction, and are provided at predetermined intervals in the circumferential direction.

The outwardly-extending portion 225 of the stator holder 220 functions as a position restriction member that restricts the positions of the winding segments 81A, 81B assembled to the core assembly CA, in the range of the coil end CE2.

The stator holder 220 is formed of, for example, metal such as aluminum or cast iron, or a carbon fiber reinforced plastic (CFRP). Although not illustrated, the stator holder 220 preferably includes a cooling medium passage through which a cooling medium such as cooling water flows, similarly to the stator holder 50.

In the range of the coil end CE1, a position restriction member 240 that restricts the positions of the winding segments 81 is attached to the boss portions 223 of the stator holder 220. The position restriction member 240 includes a circular annular portion 241, and a plurality of restriction portions 242 provided on the circular annular portion 241 at predetermined intervals. The restriction portions 242 are provided to extend in the axial direction from the circular annular portion 241. In the circular annular portion 241, a plurality of through-holes 243 extending therethrough in the axial direction is formed as bolt insertion holes. The position restriction member 240 is fixed to the stator holder 220 with bolts 245. The position restriction member 240 is formed of, for example, aluminum, an aluminum alloy, cast iron, or the like.

In the position restriction member 240, the restriction portions 242, which are placed at respective positions annularly inward with respect to the crossover portions 83 of the winding segments 81A, are provided on one of a radially inner range and a radially outer range of the circular annular portion 241, while the through-holes 243 (fixed portions) fixed to the stator holder 220 with the bolts 245 are provided on the other one of the radially inner range and the radially outer range. In this case, the restriction portions 242 and the through-holes 243 (fixed portions) are provided at positions separated radially inward and outward in the position restriction member 240. Thus, the position restriction member 240 can be fixed to the stator holder 220, without causing interference in the position restriction for the crossover portions 83 arranged in the circumferential direction. That is, in the position restriction member 240, if both the restriction portions 242 and the through-holes 243 (fixed portions) are configured to be provided at the radially outer positions, a concern may arise that, for example, the restriction portions 242 could become smaller due to restriction caused by the fixed portions. However, according to the above configuration, the restriction portions 242 can be provided as portions having sufficient strength.

The position restriction for the winding segments 81A, 81B will be described in detail with reference to FIGS. 32 to 34. In the range of the coil end CE2 (lower in the drawing), the large-diameter portion 221a and the annular wall portion 227 of the outwardly-extending portion 225 of the stator holder 220 face each other in the radial direction to form an annular groove portion therebetween, and the crossover portions 84 (unbent crossover portions) of the winding segments 81A are inserted into the annular groove. As a result, the radial and axial positions of the winding segments 81A are restricted in the range of the coil end CE2. Each of the restriction portions 228 of the outwardly-extending portion 225 is placed at a position annularly inward with respect to a corresponding one of the crossover portions 83 (bent crossover portions) of the winding segments 81B, whereby the circumferential positions of the winding segments 81B are restricted in the range of the coil end CE2.

On the other hand, in the range of the coil end CE1, in a state where the position restriction member 240 is assembled to the stator holder 220, the axial positions of the winding segments 81A are restricted by the circular annular portion 241 of the position restriction member 240. Each of the restriction portions 242 of the position restriction member 240 is placed at a position annularly inward with respect to a corresponding one of the crossover portions 83 of the winding segments 81A, whereby the circumferential and radial positions of the winding segments 81A are restricted in the range of the coil end CE1.

In the present embodiment, in the range of the coil end CE1, the position restriction member 240 (first position restriction member), which is a member provided separately from the stator holder 220, is configured to be fixed with the bolts 245. In the range of the coil end CE2, the outwardly-extending portion 225 (second position restriction member) is configured to be formed integrally with the stator holder 220, in a state of extending in the radial direction. According to this configuration, in a case where the winding segments 81A, 81B are assembled to the stator holder 220, first, the winding segments 81A, 81B can be assembled in a state of being positionally restricted by the outwardly-extending portion 225 formed integrally with the stator holder 220, and thereafter, the position restriction member 240 can be subsequently attached to the assembly including the stator holder 220 and the winding segments 81A, 81B. In this case, by forming one of the position restriction members in both axial end ranges integrally with the stator holder 220, the positions of the winding segments 81A, 81B can be appropriately restricted while the number of components can be reduced and an assembling operation can be simplified.

As illustrated in FIG. 31A, in the stator unit 200 of the present embodiment, a molded resin portion 250 is formed in a range including the stator winding 211 and the wiring module 230. A configuration of the molded resin portion 250 will be described with reference to FIG. 32A.

The molded resin portion 250 is provided to cover a range from the outwardly-extending portion 225, which is the position restriction member in the axial one end range, to the position restriction member 240 in the axial other end range, inclusive, and to cover components including the intermediate conductor portions 82 of the winding segments 81A, 81B, in the axial direction. In this case, in the coil ends CE1, CE2, a configuration is made in which a resin material enters between each of the crossover portions 83, 84 of the winding segments 81A, 81B and each of the outwardly-extending portion 225 and the position restriction member 240 to form an insulating layer.

In the range of the coil end CE2, in the outwardly-extending portion 225, a portion opposite to the stator holder 220 across the crossover portions 84 of the winding segments 81A and surrounding the crossover portions 84 from radially outside is a molding-free portion free from resin-molding (X portion in FIG. 32A). In this case, the portion of the outwardly-extending portion 225 is an exposed portion exposed to the outside without being subjected to resin-molding, and heat dissipation performance is improved.

When the winding segments 81A, 81B are compared with each other, the crossover portions 83 are bent radially inward in the winding segments 81A, and the crossover portions 83 are bent radially outward in the winding segments 81B. In this case, the winding segment 81A is considered to have a shorter conductor length, whereby a conductor resistance is considered to be lower, thereby causing the amount of heat generation to become larger. However, in the above configuration, the crossover portions 83 of the winding segments 81A are accommodated in the annular groove portion formed by the outwardly-extending portion 225, and thus the heat dissipation performance is enhanced. Heat dissipation to the refrigerant passage provided in the stator holder 220 is also suitably performed.

### Fourth Embodiment

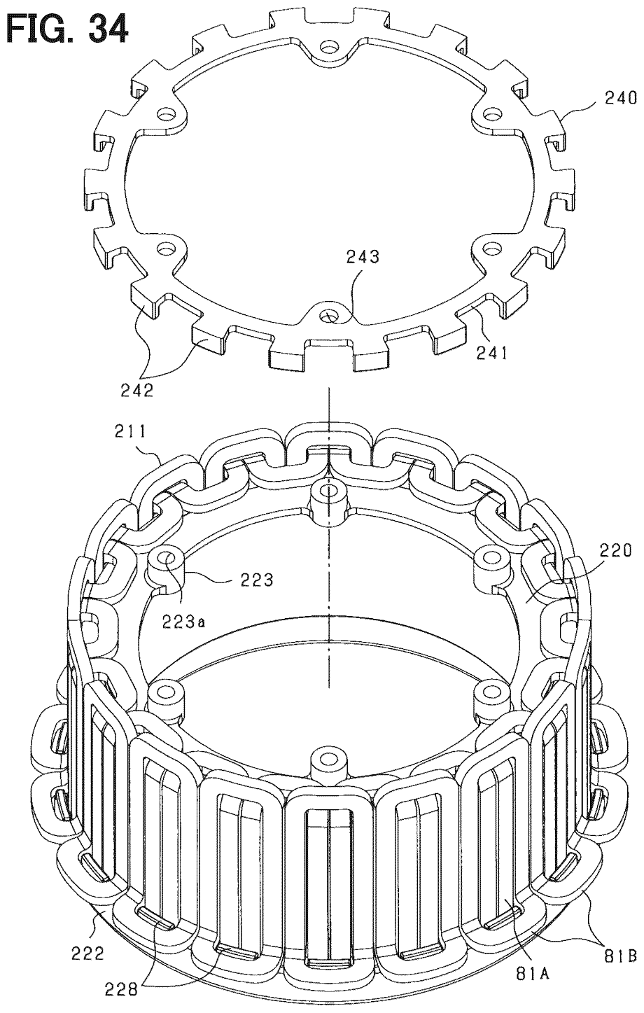

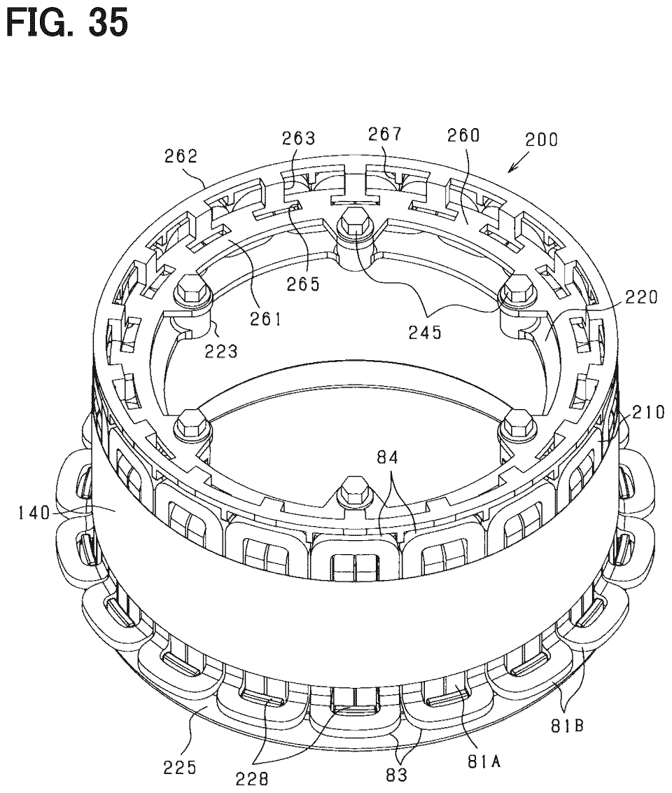

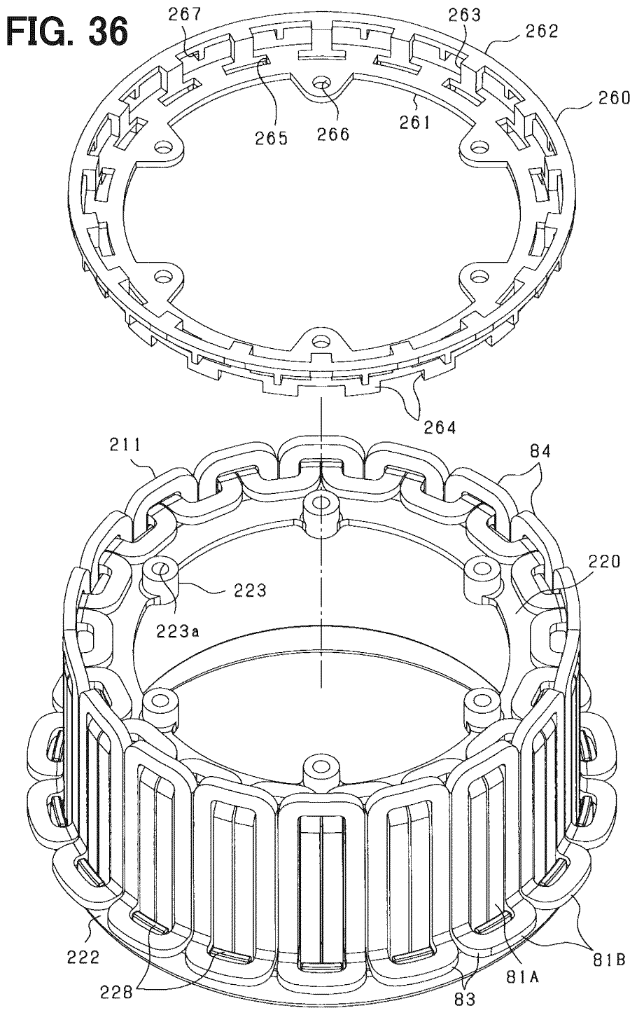

In the present embodiment, part of the stator unit 200 in the third embodiment is changed. FIG. 35 is a perspective view illustrating a configuration of a stator unit 200 according to the present embodiment, and FIG. 36 is a perspective view illustrating a state in which a position restriction member 260 is separated in the stator unit 200 according to the present embodiment. In FIG. 35, for convenience of description, the wiring module and the molded resin are not illustrated. In the present embodiment, in the stator unit 200, the position restriction member 260 is configured to be provided as a position restriction portion in the range of the coil end CE1. The stator unit 200 illustrated in FIG. 35 is different from the stator unit 200 illustrated in FIG. 31B in that the position restriction member 260 is provided instead of the position restriction member 240. However, configurations other than the configuration as to the position restriction member 260 are substantially the same. In FIG. 36, the configurations as to the core assembly CA and the stator winding 211 are the same as those in FIG. 34.

As illustrated in FIG. 36, the position restriction member 260 includes a first circular annular portion 261, a second circular annular portion 262, and a plurality of connection portions 263 connecting the circular annular portions 261, 262 in the axial direction. Multiple restriction portions 264 extending in the axial direction are provided at predetermined intervals on the first circular annular portion 261, while, in the first circular annular portion 261, multiple holes 265, 266 passing therethrough in the axial direction are provided. The holes 265 are provided at the same pitch as that of the restriction portions 264 in the circumferential direction, while the holes 265 are provided to alternate with the restriction portions 264 in the circumferential direction. The holes 266 are provided as bolt insertion holes through which the bolts 245 are inserted. Multiple restriction portions 267 extending in the axial direction are provided at predetermined intervals on the second circular annular portion 262.

As illustrated in FIG. 35, the position restriction member 260 is assembled to the stator holder 220 in the range of the coil end CE1 (upper in the drawing). In this state, the axial positions of the winding segments 81A are restricted by the first circular annular portion 261 of the position restriction member 260, while the axial positions of the winding segments 81B are restricted by the second circular annular portion 262. Each of the restriction portions 264 of the position restriction member 260 is placed at a position annularly inward with respect to a corresponding one of the crossover portions 83 (bent crossover portions) of the winding segments 81A, whereby the circumferential and radial positions of the winding segments 81A are restricted in the range of the coil end CE1. Each of the restriction portions 267 of the position restriction member 260 is placed between corresponding ones of the crossover portions 84 (unbent crossover portions) of the winding segments 81B arranged in the circumferential direction, whereby the circumferential positions of the winding segments 81B are restricted in the range of the coil end CE1.

In the present embodiment, the position restriction member 260 is configured to be in a state of being placed into respective regions annularly inward with respect to the crossover portions 83 in the winding segments 81A while being in a state of facing respective regions annularly outward with respect to the crossover portions 84 in the winding segments 81B. In this case, the position restriction member 260 can be assembled while taking into consideration the bent states of the crossover portions 83, 84 in the winding segments 81A, 81B. The position restriction member 260 can be assembled from the axial direction after the assembling of the winding segments 81A, 81B, and a manufacturing operation can be facilitated.

In the first circular annular portion 261 of the position restriction member 260, the holes 265 passing therethrough in the axial direction are provided. Thus, a flow of a resin material is promoted from an axially outer range to an axially inner range of the first circular annular portion 261 at the time of manufacturing the stator unit 200 (at the time of molding). As a result, resin-molding is performed in a range including the inside of the holes 265 and both axially opposite ranges of the first circular annular portion 261. In this case, the resin material reliably flows between each of the crossover portions 83, 84 of the winding segments 81A, 81B and the position restriction member 260, and formation of the molded resin portion 250 (formation of the insulating layer) can be appropriately performed.

### Fifth Embodiment

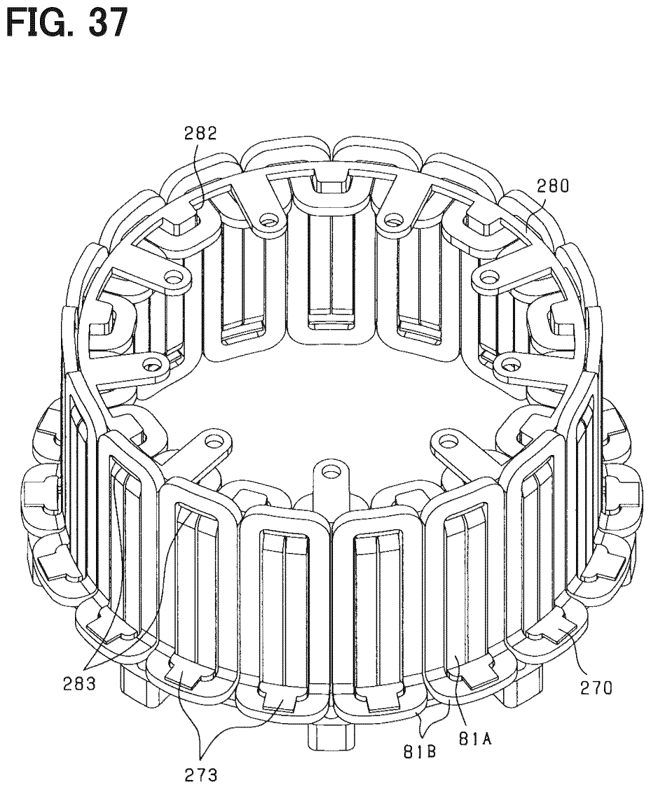

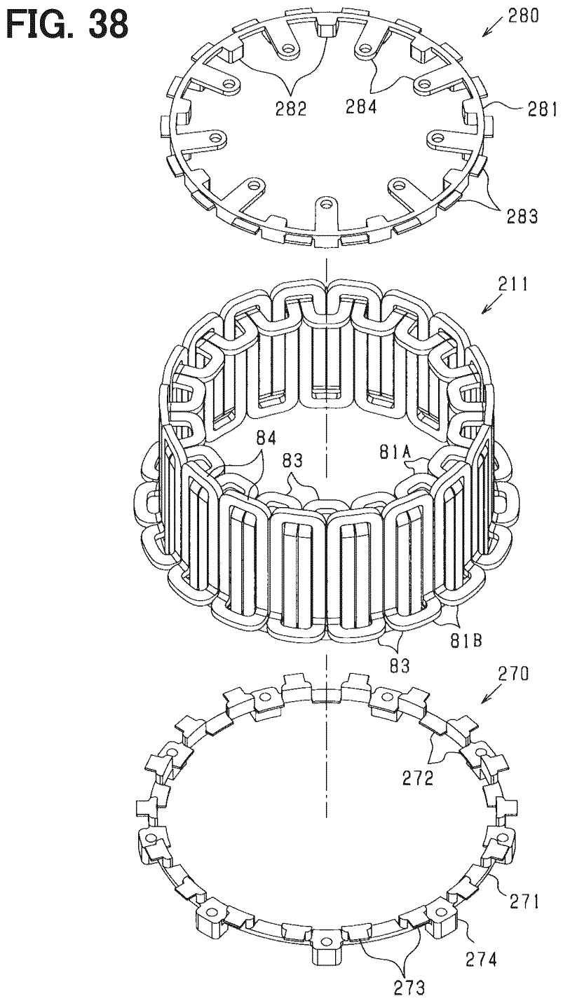

In the present embodiment, part of the stator unit 200 in the third embodiment is changed. FIG. 37 is a perspective view illustrating a configuration of a stator unit 200 according to the present embodiment, and FIG. 38 is a perspective view illustrating a state in which position restriction members 270, 280 are separated in the stator unit 200 according to the present embodiment. In FIG. 37, for convenience of description, the wiring module, the stator holder, and the molded resin are not illustrated. In the present embodiment, in the stator unit 200, the position restriction member 270 is configured to be provided as a position restriction portion in the range of the coil end CE2, and the position restriction member 280 is configured to be provided as a position restriction portion in the range of the coil end CE1. The configuration of the stator winding 211 is the same as the configuration described above.

As illustrated in FIG. 38, the position restriction member 270 includes a circular annular portion 271, a plurality of restriction portions 272 extending radially inward from the circular annular portion 271, and a plurality of restriction portions 273 extending axially from the circular annular portion 271. Each of the restriction portions 273 extends in the axial direction from the circular annular portion 271, and has a shape bent at a tip end range thereof and further extending radially outward. The circular annular portion 271 is provided with protruding portions 274 extending in the axial direction, as portions to be attached to the stator holder (not illustrated).

The position restriction member 280 includes a circular annular portion 281, a plurality of restriction portions 282 extending axially from the circular annular portion 281, and a plurality of restriction portions 283 extending radially outward from the circular annular portion 281. The circular annular portion 281 is provided with protruding portions 284 extending radially inward, as portions to be attached to the stator holder (not illustrated).

As illustrated in FIG. 37, the position restriction member 270 is assembled to the stator holder 220 in the range of the coil end CE2 (lower in the drawing). In this state, each of the restriction portions 272 of the position restriction member 270 is placed at a position annularly inward with respect to a corresponding one of the crossover portions 84 (unbent crossover portions) of the winding segments 81A, whereby the axial and circumferential positions of the winding segments 81A are restricted in the range of the coil end CE2. Each of the restriction portions 273 of the position restriction member 270 is placed at a position annularly inward with respect to a corresponding one of the crossover portions 83 (bent crossover portions) of the winding segments 81B, whereby the axial and circumferential positions of the winding segments 81B are restricted in the range of the coil end CE2.

The position restriction member 280 is assembled to the stator holder 220 in the range of the coil end CE1 (upper in the drawing). In this state, each of the restriction portions 282 of the position restriction member 280 is placed at a position annularly inward with respect to a corresponding one of the crossover portions 83 (bent crossover portions) of the winding segments 81A, whereby the circumferential and radial positions of the winding segments 81A are restricted in the range of the coil end CE1. Each of the restriction portions 283 of the position restriction member 280 is placed at a position annularly inward with respect to a corresponding one of the crossover portions 84 (unbent crossover portions) of the winding segments 81B, whereby the axial and circumferential positions of the winding segments 81B are restricted in the range of the coil end CE1.

### Sixth Embodiment

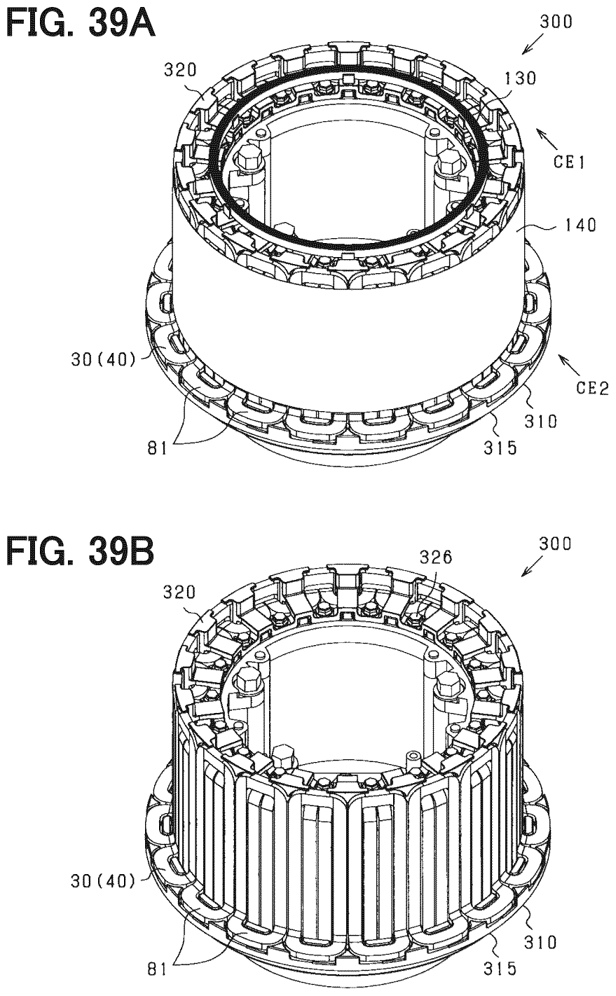

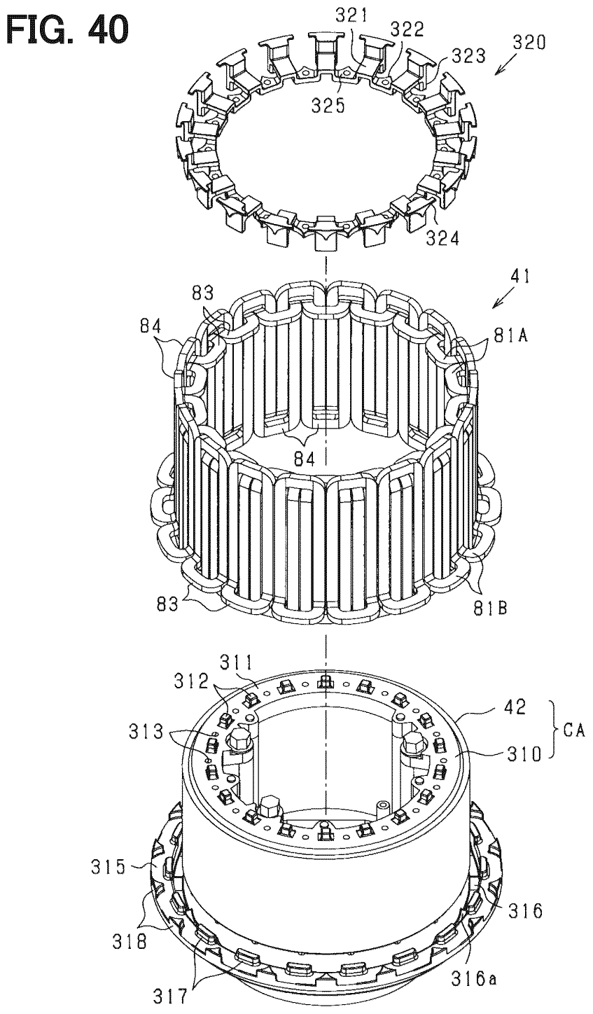

A stator unit 300 according to the present embodiment will be described. FIGS. 39A and 39B are perspective views illustrating an appearance of the stator unit 300, and FIG. 39A illustrates the stator unit 300 excluding a molded resin portion and FIG. 39B illustrates the stator unit 300 in a state where the wiring module 130 and the coil cover 140 are removed from the stator unit 300 in FIG. 39A. FIG. 40 is a perspective view illustrating main configurations in an exploded state, in the stator unit 300.

As an outline of the stator unit 300, the stator unit 300 includes the stator 40 described with reference to FIG. 2B and the like, and a stator holder 310 provided radially inward of the stator 40. The stator 40 has a toothless structure, and includes the stator winding 41 and the stator core 42. The configurations of the stator winding 41 and the stator core 42 are as described above, and the description thereof will be omitted here. A configuration is made by integrating the stator core 42 and the stator holder 310 to provide these components as the core assembly CA, and by assembling the stator winding 41 to the core assembly CA.

The stator unit 300 of the present embodiment is different from the stator unit 30 and the like described above in the stator holder 310 and a position restriction member 320 that restricts the positions of the winding segments 81 in the range of the coil end CE1.

As illustrated in FIG. 40, the stator holder 310 includes a cylindrical portion 311, and the stator core 42 is assembled to the cylindrical portion 311. On an axial end face of the cylindrical portion 311 in the range of the coil end CE1 (upper in the drawing), a plurality of protruding portions 312 extending in the axial direction is provided at predetermined intervals in the circumferential direction, and a plurality of threaded holes 313 is provided at positions between the protruding portions 312.

An outwardly-extending portion 315 extending radially outward with respect to the cylindrical portion 311 is provided at an axial end portion in the cylindrical portion 311 in the range of the coil end CE2 (lower in the drawing). At the outer periphery of the cylindrical portion 311 in the stator holder 310, an annular groove 316 is formed by the outwardly-extending portion 315. In the annular groove 316, a plurality of protruding portions 316a for restricting the circumferential positions of the unbent crossover portions 84 in the winding segments 81A is provided.

The outwardly-extending portion 315 is provided with a plurality of protruding portions 317, 318 for restricting the circumferential and radial positions of the bent crossover portions 83 in the winding segments 81B. The protruding portions 317, 318 are projecting portions extending in the circumferential direction, and are provided at predetermined intervals at circumferentially alternate positions.

The outwardly-extending portion 315 of the stator holder 310 functions as a position restriction member that restricts the positions of the winding segments 81A, 81B assembled to the core assembly CA, in the range of the coil end CE2.

The stator holder 310 is formed of, for example, metal such as aluminum or cast iron, or a carbon fiber reinforced plastic (CFRP). Although not illustrated, the stator holder 310 preferably includes a cooling medium passage through which a cooling medium such as cooling water flows, similarly to the stator holder 50.

The position restriction member 320 is formed in a circular annular shape, and restricts the axial, circumferential, and radial positions of the bent crossover portions 83 in the winding segments 81A, and restricts the axial and circumferential positions of the unbent crossover portions 84 in the winding segments 81B. In the position restriction member 320, restriction portions 321 are portions that restrict the axial positions of the bent crossover portions 83, restriction portions 322 are portions that restrict the circumferential positions of the bent crossover portions 83, and restriction portions 323 are portions that restrict the circumferential and radial positions of the bent crossover portions 83. In the position restriction member 320, restriction portions 324 are portions that restrict the axial and circumferential positions of the unbent crossover portions 84.

In the restriction portions 322, through-holes 325 extending therethrough in the axial direction are formed as bolt insertion holes. The position restriction member 320 is fixed to the stator holder 310 with bolts 326. The position restriction member 320 is formed of, for example, aluminum, an aluminum alloy, cast iron, or the like.

In the stator unit 300, as in the above embodiments, the molded resin portion 150 is provided in a range including the coil side CS and the coil ends CE1, CE2. In this case, in the coil ends CE1, CE2, a configuration is made in which a resin material enters between each of the crossover portions 83, 84 of the winding segments 81A, 81B and each of the outwardly-extending portion 315 and the position restriction member 320 to form an insulating layer.

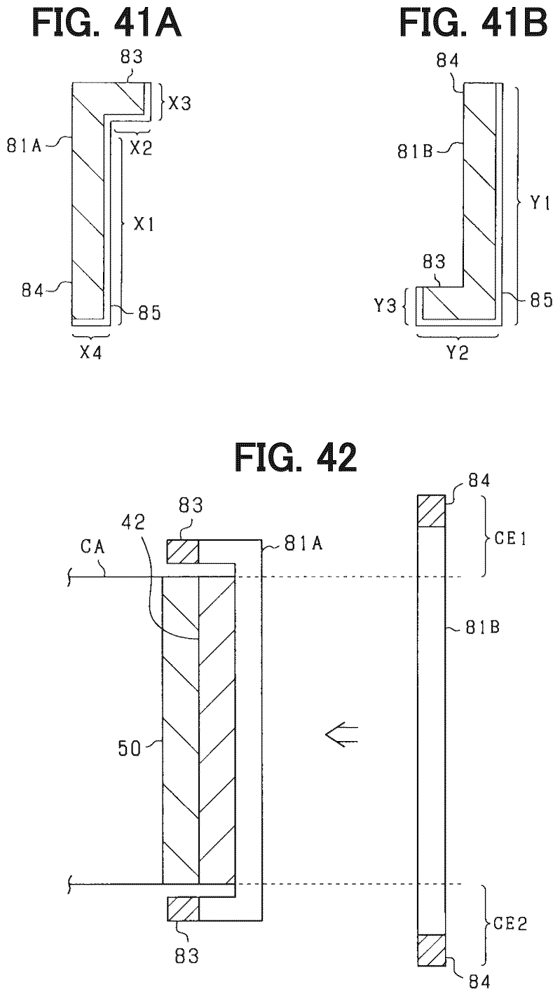

In the winding segment 81, to improve the heat dissipation performance of the stator winding 41 or to ensure the insulation property for the stator winding 41, the insulating layer 85 formed of an insulating material having heat dissipation performance higher than air is formed between the rectangular wires and on the exterior of the conductor-gathered portion in which the rectangular wires are gathered, as in the above embodiments. In this case, according to the winding holding structure of the stator unit 300, the insulating layer 85 is preferably formed at least in the ranges illustrated in FIGS. 41A and 41B on the exterior of the conductor-gathered portion. In each of FIGS. 41A and 41B, the left is a direction toward the rotator 20 and the right is a direction facing away from the rotator (a direction toward the stator core), and FIG. 41A illustrates the winding segment 81A in which the bent crossover portion 83 is bent radially inward, that is, in the direction facing away from the rotator, and FIG. 41B illustrates the winding segment 81B in which the bent crossover portion 83 is bent radially outward, that is, toward the rotator 20.

As illustrated in FIG. 41A, in the winding segment 81A, the insulating layer 85 is formed on each portion facing the core assembly CA on the exterior of the conductor-gathered portion. Specifically, the insulating layer 85 is formed on a portion X1 radially facing the core assembly CA, a portion X2 axially facing the core assembly CA, a portion X3 radially facing the protruding portion 312 of the stator holder 310 and the position restriction member 320, and a portion X4 axially facing the outwardly-extending portion 315 of the stator holder 310, on the exterior of the conductor-gathered portion.

As illustrated in FIG. 41B, in the winding segment 81B, the insulating layer 85 is formed on each portion facing the core assembly CA on the exterior of the conductor-gathered portion. Specifically, the insulating layer 85 is formed on a portion Y1 radially facing the core assembly CA, a portion Y2 axially facing the outwardly-extending portion 315 of the stator holder 310, and a portion Y3 radially facing the outwardly-extending portion 315 (protruding portions 317, 318) of the stator holder 310, on the exterior of the conductor-gathered portion.

### Other Modifications

In each of the above embodiments, in the coil ends CE1, CE2 in both axial end ranges, the molded resin portion is configured to be formed. However, the configuration may be changed to a configuration in which the molded resin portion is formed in one of the coil ends.

In each of the above embodiments, in the coil ends CE1, CE2 in both axial end ranges, the respective position restriction members each of which restricts the positions of the winding segments 81A, 81B are configured to be provided. However, the position restriction member may be configured to be provided in one of the coil ends. In this case, a configuration is preferably made in which the positions of the winding segments 81A, 81B are restricted only in the axial one end range, and in which the winding segments 81A, 81B are restrained by the coil cover 140.

In the above embodiments, the stator units 30, 200 include the stator cores 42, 212, respectively. However, the configurations may be changed to respective configurations in which the respective stator cores 42, 212 are not included. In this case, the winding segments 81A, 81B are assembled to each of the stator holders 50, 220. In the coil side CS, an insulating layer (resin material) is preferably interposed between each of the intermediate conductor portions 82 of the winding segments 81A, 81B and each of the stator holders 50, 220.

The configurations of the winding segments 81A, 81B can be changed.

In the configuration illustrated in FIG. 42, a winding segment 81A that is one of two types of winding segments 81A, 81B has a substantially C-shape in lateral view, and a winding segment 81B that is the other one of the two types of winding segments 81A, 81B has a substantially I-shape in lateral view. Of the winding segments 81A, 81B, the winding segment 81A is attached in advance to the core assembly CA and the winding segment 81B is subsequently attached to the core assembly CA. Then, in each of the coil ends CE1, CE2 in both axial end ranges, a corresponding one of position restriction members is assembled to the crossover portions of the winding segments 81A, 81B, and the crossover portions and the position restriction members are collectively subjected to resin-molding.

In the above embodiments, in the range of the coil end CE1, the axial end face of the stator core 42 and the axial end face of the stator holder 50 are flush with each other, and the axial end face of the stator core 212 and the axial end face of the stator holder 220 are flush with each other. However, these configurations may be changed. For example, in the range of the coil end CE1, the axial end faces of the stator holders 50, 220 may be configured to protrude in the axial direction with respect to the axial end faces of the stator cores 42, 212, respectively. In this case, an effect of improving heat dissipation performance can be expected.

The stator winding 41 in the rotary electric machine 10 may have a configuration including two-phase windings (a U-phase winding and a V-phase winding). In this case, a configuration is simply required in which, for example, in the winding segments 81, each pair of intermediate conductor portions 82 are provided to be separated from each other by a distance of one coil pitch, and in which a corresponding single intermediate conductor portion 82 in the other one-phase winding segment 81 is arranged between the pair of intermediate conductor portions 82.

The stator winding 41 is not limited to one using the plurality of winding segments 81, and may be configured to be formed by winding a conductor through wave winding. In this case, the stator winding 41 formed in a cylindrical shape through wave winding may be assembled to the stator core 42 formed in a cylindrical shape.

In each of the above embodiments, a surface-magnet-type rotator is used as the rotator 20. However, instead of this, an embedded-magnet-type rotator may be configured to be used.

In each of the above embodiments, the rotary electric machine 10 has an outer-rotor structure. However, this structure may be changed such that the rotary electric machine 10 may be a rotary electric machine having an inner-rotor structure. In the rotary electric machine having an inner-rotor structure, a stator is provided at a radially outer position, and a rotator is provided at a radially inner position.

As the rotary electric machine 10, instead of a revolving-field-type rotary electric machine in which a field element is a rotator and an armature is a stator, a revolving-armature-type rotary electric machine can also be adopted in which an armature is a rotator and a field element is a stator.

The rotary electric machine 10 may be used in various purposes other than use as a motor for traveling of a vehicle. The rotary electric machine 10 may be a rotary electric machine widely used in a mobile body including an aircraft, or a rotary electric machine used in an electric device for industrial use or household use.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A rotary electric machine comprising:
a field element having magnetic poles;
an armature having a toothless structure, the armature including a multiphase armature winding, the field element and the armature facing each other in a radial direction of the rotary electric machine;
a winding holding member having a cylindrical shape, the armature winding being attached to the winding holding member such that conductor portions of the armature winding are arranged in a circumferential direction of the rotary electric machine;
a cylindrical covering member provided on a coil side of the armature that faces the field element in the radial direction, the cylindrical covering member having a cylindrical shape and covering the conductor portions of the armature winding, the conductor portions of the armature winding are interposed between the winding holding member and the cylindrical covering member;
a position restriction member provided on a coil end of the armature, the position restriction member being a portion of the winding holding member or fixed to the winding holding member, and configured to restrict displacement of the armature winding in the circumferential direction relative to the winding holding member; and
a resin layer including
a coil side resin portion filling a gap between the winding holding member and the cylindrical covering member on the coil side, and
a coil end resin portion covering a portion of the armature winding restricted in displacement by the position restriction member on the coil end and being continuous with the coil side resin portion in an axial direction of the rotary electric machine.

2. The rotary electric machine according to claim 1, wherein
the cylindrical covering member is formed of a non-magnetic material.

3. The rotary electric machine according to claim 1, wherein
the cylindrical covering member is a long member having an elongated shape and wound around outer peripheries of the conductor portions.

4. The rotary electric machine according to claim 1, wherein
each of the conductor portions is formed of gathered conductor wires,
each of the conductor portions has a quadrangular shape in cross section, and
the resin is interposed between each of the conductor portions and the winding holding member facing each other in the radial direction.

5. The rotary electric machine according to claim 1, wherein
each of the conductor portions is formed of gathered conductor wires,
each of the conductor portions has a quadrangular shape in cross section, and
the resin is interposed between each of the conductor portions and the cylindrical covering member facing each other in the radial direction.

6. The rotary electric machine according to claim 1, wherein
the armature winding faces the field element in an air gap forming range, the air gap forming range being a predetermined range extending in the axial direction,
the armature winding has a first end portion that is one of opposite ends of the armature winding in the axial direction, and a second end portion that is another of the opposite ends in the axial direction,
the first end portion includes a bent portion bent toward the field element in the radial direction,
the cylindrical covering member extends toward the second end portion up to a boundary position of the air gap forming range, and extends toward the first end portion up to a position before another boundary position of the air gap forming range, and
the resin is not provided on a face of the cylindrical covering member facing the field element.

7. A method of manufacturing a rotary electric machine, the rotary electric machine including a field element having magnetic poles, and an armature having a toothless structure, the armature including a multiphase armature winding, the field element and the armature being arranged to face each other in a radial direction of the rotary electric machine, the method comprising:
attaching the armature winding to a winding holding member having a cylindrical shape to cause conductor portions of the armature winding to be arranged in a circumferential direction of the rotary electric machine;
attaching a cylindrical covering member to a side of each of the conductor portions facing away from the winding holding member such that the cylindrical covering member covers a coil side of the armature winding that faces the field element in the radial direction; and
filling a gap between the winding holding member and the cylindrical covering member with resin, wherein
the attaching the armature winding includes restricting displacement of the armature winding relative to the winding holding member with a position restriction member provided on an coil end of the armature, the position restriction member being a portion of the winding holding member or fixed to the winding holding member, and
the filling the gap with resin incudes forming a resin layer including
a coil side resin portion filling a gap between the winding holding member and each of the conductor portions and a gap between each of the conductor portions and the cylindrical covering member with the resin on the coil side of the armature without filling a gap between the cylindrical covering member and the field element with the resin, and
a coil end resin portion covering a portion of the armature winding restricted in displacement by the position restriction member on the coil end of the armature and being continuous with the coil side resin portion in an axial direction of the rotary electric machine.
